(19) United States
(12) Patent Application Publication
(10) Pub. No.: US 2025/0294550 A1
(43) Pub. Date: Sep. 18, 2025

(54) USER EQUIPMENT CAPABILITY ON MAXIMUM NUMBER OF SUPPORTED LAYERS FOR SIMULTANEOUS UPLINK TRANSMISSIONS

(71) Applicant: QUALCOMM Incorporated, San Diego, CA (US)

(72) Inventors: Mostafa KHOSHNEVISAN, San Diego, CA (US); Yitao CHEN, San Marcos, CA (US); Fang YUAN, Beijing (CN); Yan ZHOU, San Diego, CA (US); Tao LUO, San Diego, CA (US); Jing SUN, San Diego, CA (US); Xiaoxia ZHANG, San Diego, CA (US)

(21) Appl. No.: 18/862,658

(22) PCT Filed: Jun. 29, 2022
(86) PCT No.: PCT/CN2022/102211

§ 371 Date: Nov. 4, 2024

(51) Int. Cl. H04W 72/1268; H04B 7/0413; H04L 5/00; H04W 72/21

(52) U.S. Cl. CPC H04W 72/1268; H04B 7/0413; H04L 5/0051; H04W 72/21

(57) ABSTRACT

Certain aspects of the present disclosure provide techniques for wireless communication by a user equipment (UE). For example, the UE may transmit, to a plurality of transmission and reception points (TRPs), a layer parameter based on a maximum number of multiple input multiple output (MIMO) uplink layers that are supported by the UE for uplink communication to the plurality of TRPs. The UE may receive, from at least one TRP of the plurality of TRPs, uplink scheduling information responsive to transmitting the layer parameter. The UE may further transmit, to each of the plurality of TRPs, a physical uplink shared channel (PUSCH) communication according to the uplink scheduling information.

### BACKGROUND

### Field of the Disclosure

Aspects of the present disclosure relate to wireless communications, and more particularly, to techniques for reporting and interpreting user equipment capabilities on a maximum number of supported layers for uplink communication to multiple transmission reception points.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes transmitting, to a plurality of transmission and reception points (TRPs), a layer parameter based on a maximum number of multiple input multiple output (MIMO) uplink layers that are supported by the UE for uplink communication to the plurality of TRPs; receiving, from at least one TRP of the plurality of TRPs, uplink scheduling information responsive to transmitting the layer parameter; and transmitting, to each of the plurality of TRPs, a physical uplink shared channel (PUSCH) communication according to the uplink scheduling information.

Another aspect provides a method for wireless communication by a transmission and reception point (TRP). The method includes receiving, from a user equipment (UE), a layer parameter; determining, based on the layer parameter, a maximum number of multiple input multiple output (MIMO) uplink layers supported by the UE for uplink communication to a plurality of transmission and reception points (TRPs); determining uplink scheduling information based on the maximum number of MIMO uplink layers; transmitting, to the UE, the uplink scheduling information; and receiving, from the UE, a physical uplink shared channel (PUSCH) communication according to the uplink scheduling information.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 is an example diagram illustrating communication between multiple transmission reception points (TRPs) and a user equipment (UE).

FIG. 6 is an example diagram illustrating two sets of physical uplink shared channel (PUSCH) transmissions configured for time division multiplexing (TDM) and scheduled by a single DCI.

FIG. 7 is an example diagram illustrating two sets of PUSCH transmissions configured for space division multiplexing (SDM).

FIG. 8A is an example diagram illustrating a Scheme A and a Scheme B of frequency division multiplexing (FDM) in two sets of PUSCH transmissions.

FIG. 8B is an example diagram illustrating two sets of PUSCH transmissions configured for FDM.

FIG. 9 is an example diagram illustrating two PUSCH transmissions that overlap in the time domain.

FIG. 10A is a table showing a parameter defining a maximum number of multiple-input and multiple-output (MIMO) layers for a physical downlink shared channel (PDSCH).

FIG. 10B is a table showing a parameter defining a maximum number of MIMO layers for a codebook-based PUSCH communication and showing a parameter defining a maximum number of MIMO layers for an non-codebook-based PUSCH communication.

FIG. 11 is a table showing different interpretation operations depending on a parameter reported by the UE to indicate a maximum number of MIMO layers supported by the UE for downlink in a multiple TRP situation.

FIG. 12 depicts a process flow for communications in a network between a user equipment (UE) and a TRP.

FIG. 13 depicts a method for wireless communications.

FIG. 14 depicts a method for wireless communications.

FIG. 15 depicts aspects of an example communications device.

FIG. 16 depicts aspects of an example communications device.

### DETAILED DESCRIPTION

Aspects of the present disclosure provide apparatuses, methods, processing systems, and computer-readable mediums for reporting and interpreting user equipment capabilities on a maximum number of supported layers for uplink communication to the multiple transmission reception points.

A network entity such as a base station and a transmission and reception point (TRP) may set up a downlink communication to a user equipment (UE) and may also schedule an uplink communication for the UE. For example, the TRP may transmit uplink scheduling information (e.g., uplink grant) to the UE, such that the UE may schedule its uplink communication based on the uplink scheduling information. The TRP may determine the uplink scheduling information based on UE indicated capabilities for the uplink communication. The UE may transmit a legacy parameter to report the UE capabilities associated with a maximum number of multiple-input and multiple-output (MIMO) layers for uplink communication with a single TRP, such that the TRP may determine the uplink scheduling information based on the parameter. However, a mechanism to report UE capabilities associated with a maximum number of MIMO layers for uplink communication with multiple TRPs is currently lacking.

A first approach to report UE capabilities associated with a maximum number of MIMO layers for uplink communication with multiple TRPs is to repurpose the legacy parameter (for a single TRP) to report UE capabilities associated with a maximum number of MIMO layers for uplink communication with multiple TRPs. In particular, a TRP may receive or may be preconfigured with an interpretation parameter indicating how to interpret the value of the legacy parameter (e.g., to determine the UE capabilities associated with a maximum number of MIMO layers for uplink communication with multiple TRPs. As such, when the TRP receives (e.g., from the UE) or retrieves the legacy parameter, the TRP may interpret the legacy parameter based on the interpretation parameter. Because the legacy parameter is repurposed, this approach provides a new mechanism to report UE capabilities associated with a maximum number of MIMO layers for uplink communication with multiple TRPs, without introducing a new parameter for reporting such information.

A second approach is to utilize a new parameter (e.g., non-legacy parameter) specifically for indicating the UE capabilities associated with a maximum number of MIMO layers for uplink communication with multiple TRPs. When a TRP receives the non-legacy parameter, the TRP may interpret the non-legacy parameter to retrieve the UE capabilities. By using a non-legacy parameter, this approach allows the UE to report various types of information associated with the UE capabilities for the maximum number of MIMO layers for uplink communication with multiple TRPs.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

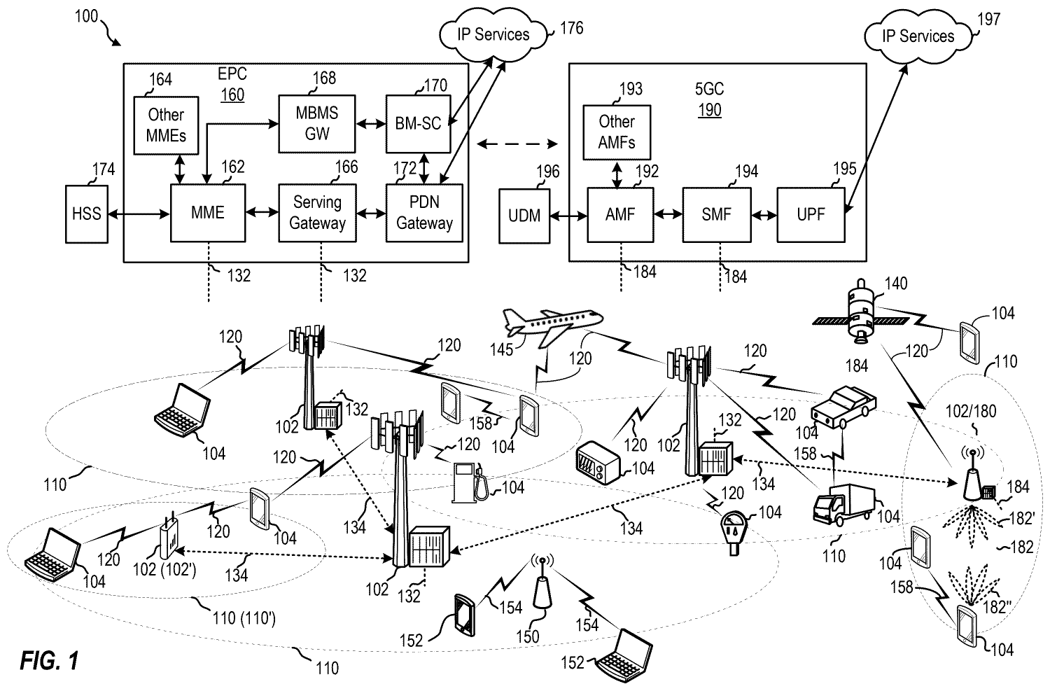

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

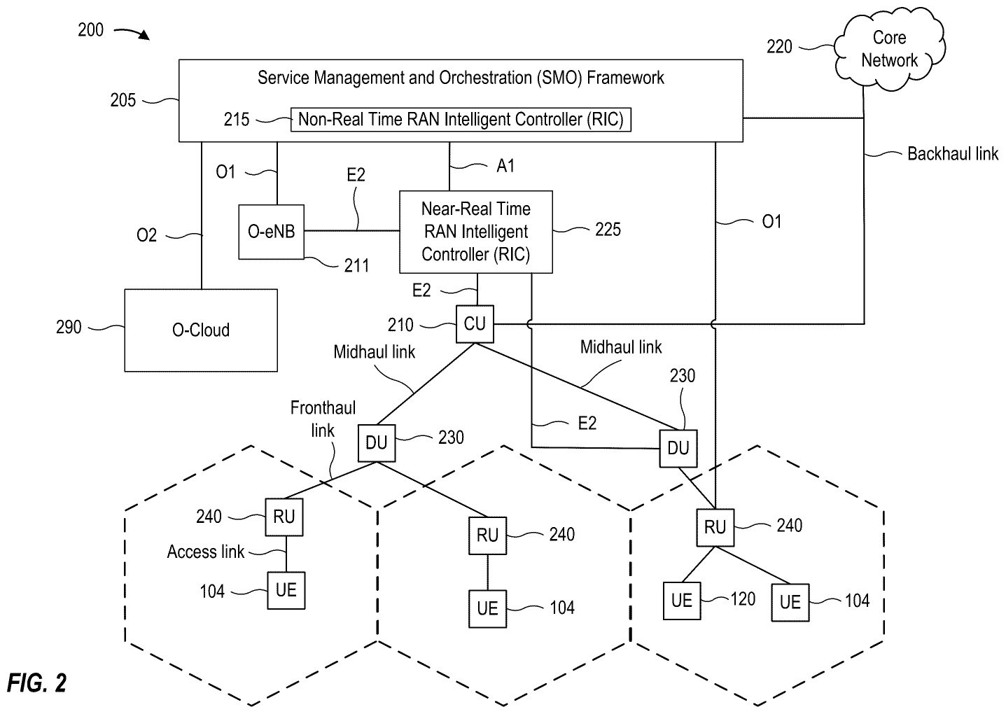

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mm Wave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

In some examples, a BS 102 may include two or more transmission and reception points (TRPs) that may be collocated or non-collocated. Each TRP may communicate on the same or different carrier frequency within the same or different frequency band. In an example, the UE 104 may communicate with multiple TRPs using multiple beams in different directions.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUs) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

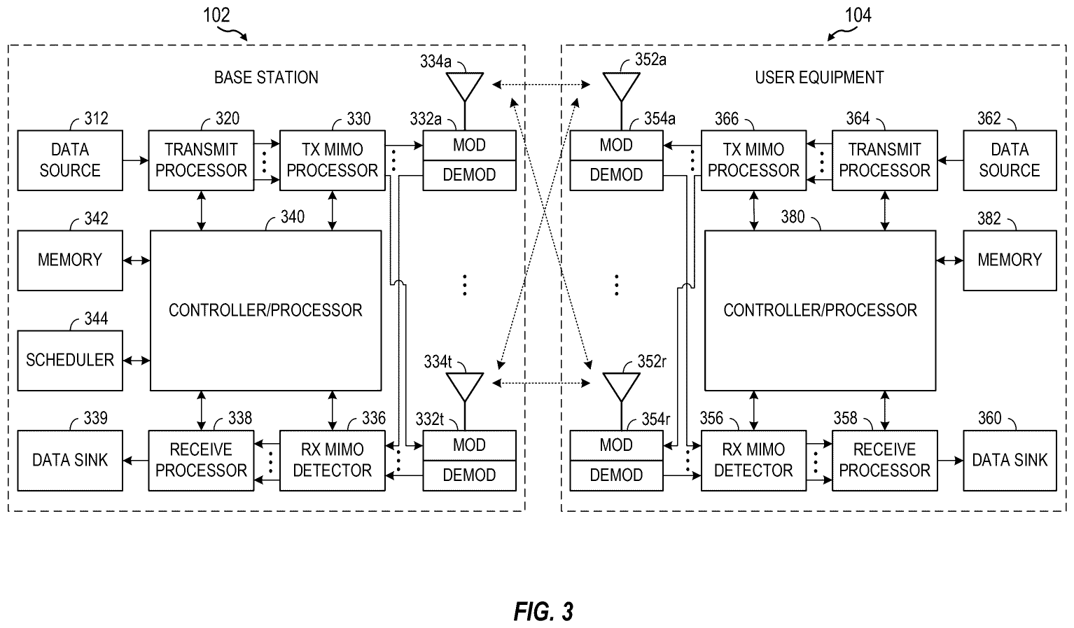

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the physical uplink shared channel (PUSCH)) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

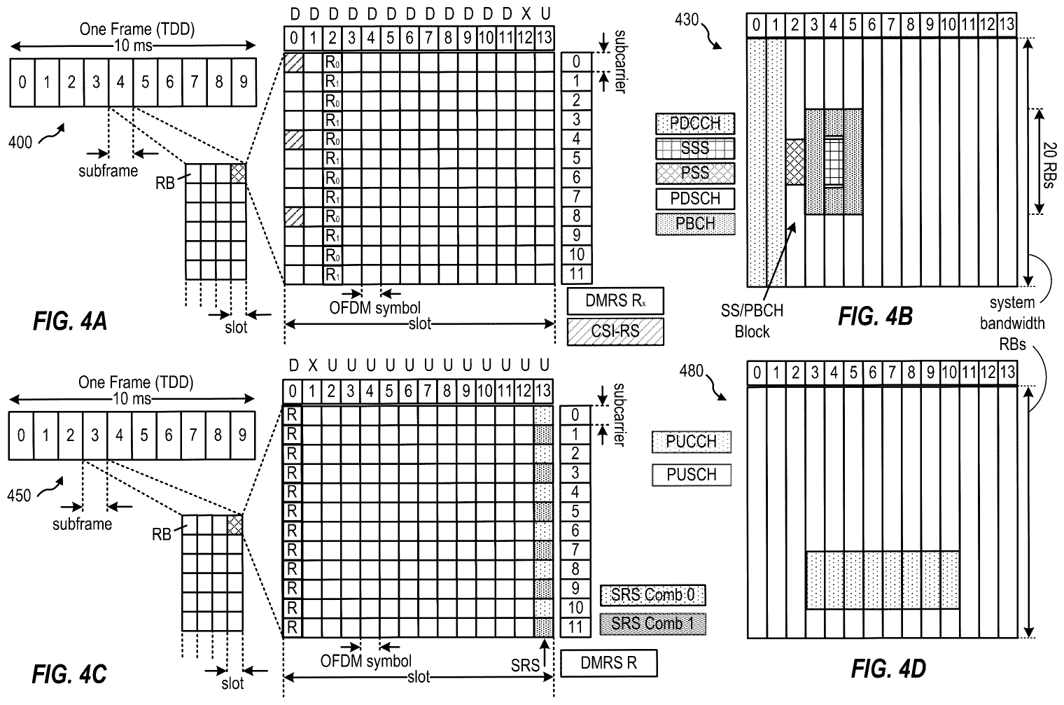

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where Dis DL, U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24× 15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

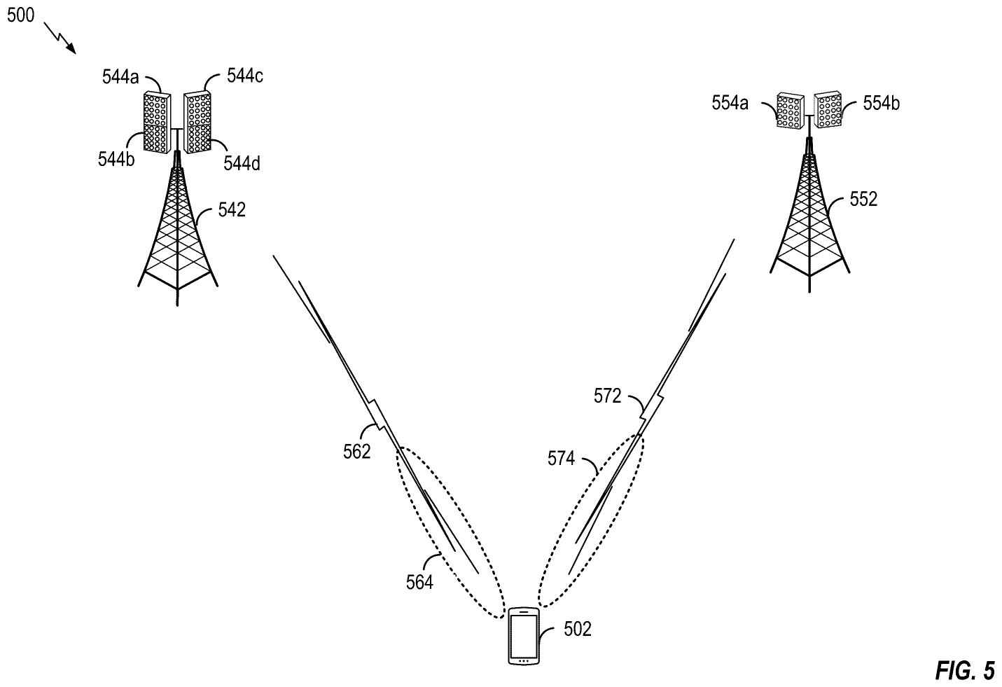

FIG. 5 is an example diagram 500 illustrating communication between multiple transmission reception points (TRPs) and a UE. The UE 502 may be configured to communicate with a first TRP 542 and a second TRP 552, each of which may be a respective TRP in a coordinated multi-point (COMP) network configuration. It is noted that the UE 502 may communicate with any number of TRPs. The first TRP 542 is a multi-panel base station with two antenna arrays, each of which including two antenna panels, where one antenna array includes antenna panels 544a and 544b, and the other antenna array includes antenna panels 544c and 544d. The antenna panels 544a and 544b may be in a first antenna array and the antenna panels 544c and 544d may be in a second antenna array of the first TRP 542. The first TRP 542 may be configured to communicate with the UE 502 over a communication link 562 using, for example, one or more antenna panels (e.g., antenna panels 544c and 544d) of an antenna array of the first TRP 542. The UE 502 may communicate with the first TRP 542 using a first beam 564 of the UE 502 in a direction toward the first TRP 542.

For beamformed communication, the antenna elements of an antenna array (e.g., panels 544c and 544d) may be mapped to antenna ports for generation of beams. Here, the term antenna port refers to a logical port (e.g., a beam) over which a signal (e.g., a data stream or layer) may be transmitted. In an example, an antenna array may include 128 antenna elements (e.g., within a 16×8 array) that may be mapped to 32 antenna ports by an 8×1 combiner. For MIMO transmissions, each layer (or data stream) may be mapped to one of the antenna ports. For example, the first TRP 542 may maintain a codebook of precoding matrices and map the different transmission layers to a set of antenna ports on the first TRP 542 using a selected precoding matrix. The precoding matrix provides the appropriate weightings to be applied to each layer for generation of the respective beam for each layer. The precoding matrix may be selected based on the PMI fed back from the UE 502 in a CSI report. For example, using the PMI, the first TRP 542 may select a particular precoding matrix from a codebook for a MIMO transmission.

The second TRP 552 is a single-panel TRP with two antenna arrays, each including a single antenna panel, where one antenna array includes antenna panel 554a and the other antenna array includes antenna panel 554b. The second TRP 552 may be configured to communicate with the UE 502 over a communication link 572 using, for example, either of arrays of the single-panel antenna panel 554a or arrays of the single-panel antenna panel 554b. The UE 502 may communicate with the second TRP 552 using a second beam 574 of the UE 502 in a direction toward the second TRP 552. Although not shown in FIG. 5, the UE 502 may communicate with one or more additional TRPs, each having single-panel or multi-panel antenna arrays.

### Aspects Related to Reporting and Interpreting UE Capabilities

To understand aspects of reporting and interpreting a UE's capabilities, particularly with respect to indicating supported MIMO layers, it is useful to understand some aspects of PUSCH transmissions. UEs such as the UE 104 of FIG. 1 and the UE 502 of FIG. 5 may support two types of PUSCH transmissions, which are codebook (CB) based PUSCH transmissions and non-codebook (NCB) based PUSCH transmissions. Depending on a channel state information (CSI) and resource capabilities of the UE, one type of PUSCH transmissions may be preferred over the other type.

In CB-based PUSCH transmissions, the UE may be configured with a single SRS resource set with a usage set to “codebook.” In the CB-based PUSCH transmissions, a maximum of 4 SRS resources may be configured within a single SRS resource set for the UE, where each SRS resource may have one or more ports. In an aspect, an SRS resource indicator (SRI) field in a UL DCI (e.g., for scheduling a PUSCH) may indicate one SRS resource. Hence, for a single SRS resource set with 4 SRS resources, 4 separate DCIs may be transmitted to the UE, each DCI indicating a respective SRS resource of the 4 SRS resources. Further, in an aspect, a number of layers (rank) and a precoder (e.g., a transmit precoding matrix index (TPMI)) for the scheduled PUSCH may be determined from a separate field in the UL DCI, where the separate field may be a “Precoding information and number of layers” field.

In NCB-based PUSCH transmissions, the UE may be configured with a single SRS resource set with a usage set to “non-codebook.” In the NCB-based PUSCH transmissions, a maximum of 4 SRS resources may be configured within a single SRS resource set for the UE, where each SRS resource may have a single port. In an aspect, an SRI field in a UL DCI (e.g., for scheduling a PUSCH) may indicate one or more SRS resources. The number of SRS resources indicated by the UL DCI may determine a rank for the scheduled PUSCH transmission. The rank may indicate a number of layers and one port may represent one layer. Hence, the number of SRS resources indicated by the UL DCI may determine a number of layers, and thus may determine a rank. The UE may transmit a PUSCH using the same precoder as a precoder indicated by the UL DCI that indicates the SRS resources.

Multiple PUSCH transmissions may be performed using one of several different techniques. For example, the UE may perform multiple PUSCH transmissions using at least one of time division multiplexing (TDM), space division multiplexing (SDM), frequency division multiplexing (FDM), or time-domain overlapping.

In an aspect, a single DCI may be used to schedule multiple PUSCH transmissions and their repetitions in TDM manner, where the multiple PUSCH transmissions may have different transmission parameters (e.g., beam/spatial relation/transmission configuration indicator (TCI) state, power control, precoding). A beam may be referred to as a spatial relation or a TCI state.

In an example, PUSCH transmissions (e.g., scheduled by a single DCI), may belong to two sets of PUSCH transmissions, where each set has its own beam, power control parameters, etc. In this example, the first set may include PUSCH transmissions of first PUSCH data and the second set may include PUSCH transmissions of second PUSCH data. Different transmissions may be associated with the same transport block (TB). Hence, for example, the first set may include a PUSCH transmission of the first PUSCH data and one or more repetition of the PUSCH transmission of the first PUSCH data, while the second set may include a PUSCH transmission of the second PUSCH data and one or more repetition of the PUSCH transmission of the second PUSCH data.

To achieve this, the two sets of PUSCH transmissions may respectively correspond to two SRS resource sets. The first set may involve PUSCH transmissions of the first PUSCH data to a first TRP and a second set may involve PUSCH transmissions of the second PUSCH data to a second TRP. The single DCI may indicate two beams and/or two sets of power control parameters and two corresponding SRI fields for both CB-based and NCB-based PUSCH transmissions. For a CB-based PUSCH transmission, the single DCI may further include two TPMI fields to indicate two precoders respectively for the two sets of PUSCH transmissions.

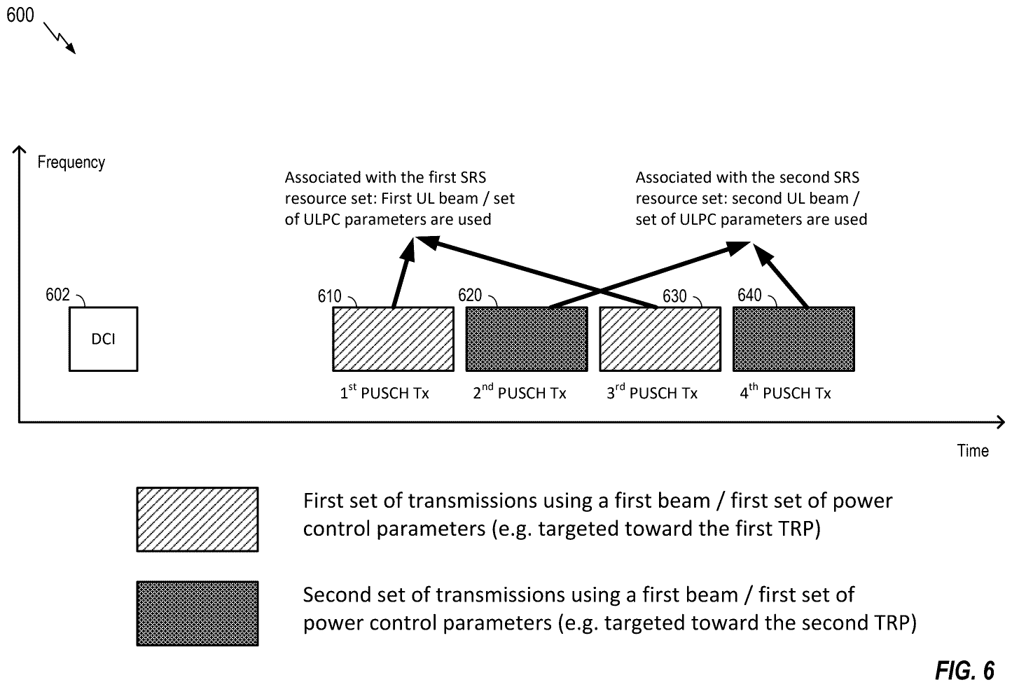

FIG. 6 is an example diagram 600 illustrating two sets of PUSCH transmissions configured for TDM and scheduled by a single DCI. As shown in FIG. 6, a UE (e.g., UE 104) may receive a single DCI 602 and schedules two sets of PUSCH transmissions based on the single DCI 602. The two sets of PUSCH transmissions may include a first set and a second set. The first set includes a first PUSCH transmission 610 of first PUSCH data and a third PUSCH transmission 630 of the first PUSCH data, where the third PUSCH transmission 630 may be a repetition of the first PUSCH transmission 610. The second set includes a second PUSCH transmission 620 of second PUSCH data and a fourth PUSCH transmission 640 of the second PUSCH data, where the fourth PUSCH transmission 640 may be a repetition of the second PUSCH transmission 620. The UE may sequentially transmit the first PUSCH transmission 610, the second PUSCH transmission 620, the third PUSCH transmission 630, and the fourth PUSCH transmission 640, in TDM manner.

In FIG. 6., the first set of the PUSCH transmissions may be associated with a first SRS set, and may be performed using a first UL beam and a first set of UL power control parameters. The first UL beam used in the first set of the PUSCH transmissions may be in a direction toward a first TRP. The second set of the PUSCH transmissions may be associated with a second SRS set, and may be performed using a second UL beam and a second set of UL power control parameters. The second UL beam used in the second set of the PUSCH transmissions may be in a direction toward a second TRP.

In an aspect, a single DCI may be used to schedule multiple PUSCH transmissions and their repetitions using space division multiplexing (SDM). In an example, PUSCH transmissions (e.g., scheduled by a single DCI) may belong to two sets of PUSCH transmissions, where the first set may include PUSCH transmissions of first PUSCH data and the second set may include PUSCH transmissions of second PUSCH data. The single DCI may schedule the two sets of PUSCH transmissions respectively with two sets of DMRS ports and two sets of layers transmitted from two antenna panels respectively for the two sets of PUSCH transmissions, where the two antenna panels are configured with different transmit beams, precoders, and power control parameters. The different layers may correspond to different portions in the space domain.

The two sets of layers may be respectively associated with two SRS resource sets. The single DCI may include an SRS resource set indicator field, two SRI fields, and two TPMI fields for the two sets of PUSCH transmissions, respectively. The SRS resource set indicator field may indicate whether the UE communicates with a single TRP or with multiple TRPs. The UE may configure a rank combination for the two sets of PUSCH transmissions, based on a channel quality (e.g., indicated by an MCS), where the rank may indicate a number of layers. For example, if a maximum of 2 layers is configured for each of the two sets of PUSCH transmissions, possible rank combinations may be 1 layer for the first set+1 layer for the second set, 1 layer for the first set+2 layers for the second set, 2 layers for the first set+1 layer for the second set, and 2 layers for the first set+2 layers for the second set. For example, when the channel quality is good (e.g., exceeding a certain threshold), more information may be transmitted and thus a higher rank (e.g., more layers) is used for the PUSCH transmission. In SDM, per PUSCH occasion, two beams may be utilized simultaneously. On the other hand, in TDM, only one beam is utilized per PUSCH occasion.

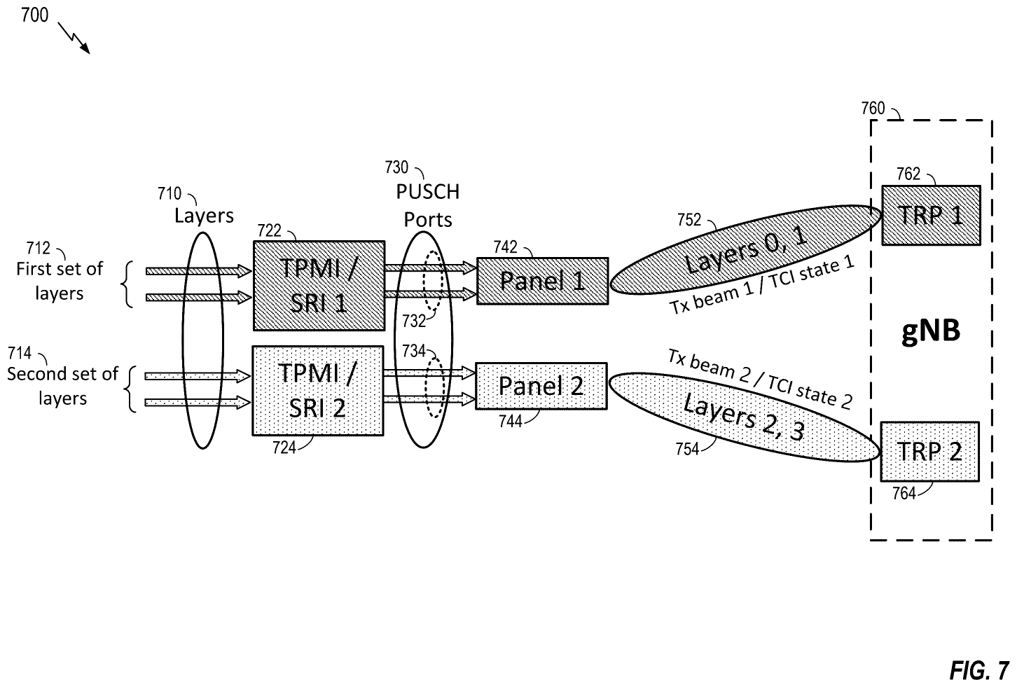

FIG. 7 is an example diagram 700 illustrating two sets of PUSCH transmissions configured for SDM manner. In FIG. 7, there are 4 total layers 710, which are divided into 2 layers for each PUSCH transmission such that each set of PUSCH transmissions may utilize 2 layers. Based on a single DCI, the UE (e.g., UE 104) may utilize a first set 712 of layers (layers 0, 1) to perform a first set of PUSCH transmissions including a transmission of first PUSCH data (e.g., using layer 0) and a repetition of the transmission of the first PUSCH data (e.g., using layer 1). Further, based on the single DCI, the UE may utilize a second set 714 of layers (layers 2, 3) to perform a second set of PUSCH transmissions including a transmission of second PUSCH data (e.g., using layer 2) and a repetition of the transmission of the second PUSCH data (e.g., using layer 3). In particular, the first set 712 of layers may be configured to utilize a first antennal panel 742 generating a first beam 752 (first TCI state) in a first direction toward a first TRP 762, and the second set 714 of layers may be configured to utilize a second antenna panel 744 generating a second beam 754 (second TCI state) in a second direction toward a second TRP 764. The first beam 752 may be associated with a first SRS resource set, and the second beam 754 may be associated with a second SRS resource set. In an aspect, the first TRP 762 and the second TRP 764 may reside within a single gNB 760, as shown FIG. 7. In another aspect, the first TRP 762 and the second TRP 764 may reside in two separate gNBs.

In an NCB-based communication, the layers are directly mapped to respective PUSCH ports. Hence, in an NCB-based communication, the layers of the first set 712 may be directly mapped to first PUSCH ports 732 of the PUSCH ports 730, respectively, and the layers of the second set 714 may be directly mapped to second PUSCH ports 734 of the PUSCH ports 730, respectively. In CB-based communication, a first TPMI 722 is used to determine the first set 712 of layers so that the layers of the first set 712 may be respectively mapped to first PUSCH ports 732 of the PUSCH ports 730. Similarly, in CB-based communication, a second TPMI 724 is used to determine the layers of the second set 714 of layers so that the layers of the second set 714 may be respectively mapped to second PUSCH ports 734 of the PUSCH ports 730.

In an aspect, a single DCI may be used to schedule multiple PUSCH transmissions and their repetitions using frequency division multiplexing (FDM). In an example, PUSCH transmissions (e.g., scheduled by a single DCI) may belong to two sets of PUSCH transmissions, where the first set may include PUSCH transmissions of first PUSCH data and the second set may include PUSCH transmissions of second PUSCH data. The single DCI may be used to schedule the two sets of PUSCH transmissions respectively with two sets of RBs transmitted from two antenna panels respectively for the two sets of PUSCH transmissions, where the two antenna panels are configured with different transmit beams, precoders, and power control parameters.

The two sets of RBs may be respectively associated with two SRS resource sets. Further, the two sets of RBs may exist within the same time range, but within different frequency ranges. The single DCI may include an SRS resource set indicator field, two SRI fields, and two TPMI fields for the two sets of PUSCH transmissions, respectively. At least two error correction schemes may be available in FDM, Scheme A with a single redundancy version (RV) and Scheme B with two RVs.

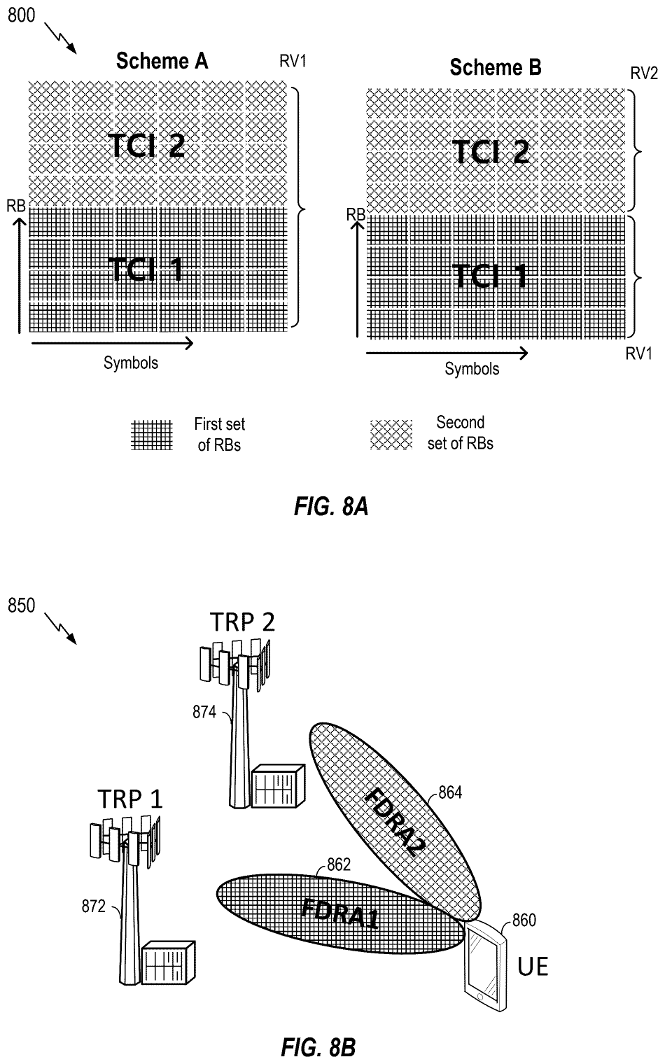

FIG. 8A is an example diagram 800 illustrating a Scheme A and a Scheme B of FDM in two sets of PUSCH transmissions. In Scheme A and Scheme B, a first set of RBs may be associated with a first TCI state (first beam) and a second set of RBs may be associated with a second TCI state (second beam), where the first beam is used for the first set of PUSCH transmissions and the second beam is used for the second set of PUSCH transmissions. In Scheme A, because a single RV is used, the single RV spans over both the first set of RBs and the second set of RBs, and thus is used for joint rate matching. In Scheme B, because two RVs are used, a first RV spans over the first set of RBs and a second RV spans over the second set of RBs, and thus the first RV and the second RV are used separately for separate rate matching.

FIG. 8B is an example diagram 850 illustrating two sets of PUSCH transmissions configured for FDM. In FIG. 8B, the UE 860 may utilize a first beam 862 associated with a first frequency domain resource allocation (FDRA) to transmit the first set of PUSCH transmissions and a second beam 864 with a second FDRA to transmit the second set of PUSCH transmissions. Hence, in FDM, the use of the first beam 862 and the use of the second beam 864 are different in frequency domain resource allocations. The first beam 862 may be in a direction toward a first TRP 872 and thus the first set of PUSCH transmissions are sent to the first TRP 872. The second beam 864 may be in a direction toward a second TRP 874 and thus the first set of PUSCH transmissions are sent to the second TRP 874. The single DCI used to schedule the first set and the second set of the PUSCH transmissions may be received from the first TRP 872 and/or the second TRP 874.

In an aspect, multiple PUSCH transmissions of different PUSCH data within the same serving cell or component carrier (CC) may be at least partially or fully overlapping with each other in the time domain, while the multiple PUSCH transmissions of different PUSCHs may or may not overlap in the frequency domain. This may be enabled by a multi-DCI based multiple TRP (multi-TRP) framework, where the two different PUSCHs may be associated with different coreset pool index (e.g., coresetPoolIndex) values. Hence, two different PUSCHs may be scheduled by receiving two separate DCIs from two different TRPs. Hence, this is different from SDM PUSCH transmissions or FDM PUSCH transmissions explained above with a single-DCI based framework, where two different PUSCHs may be transmitted simultaneously.

The first PUSCH may be associated with the first SRS resource set. The first PUSCH may be associated with a coreset pool index value of 0, which indicates that the first PUSCH is scheduled by a first TRP. The first PUSCH may be transmitted using a first beam, a first TCI state, first power control parameters, and/or a first precoder. The second PUSCH is associated with the second SRS resource set. The second PUSCH may be associated with a coreset pool index value of 1, which indicates that the second PUSCH is scheduled by a second TRP. The second PUSCH may be transmitted using a second beam, a second TCI state, second power control parameters, and/or a second precoder.

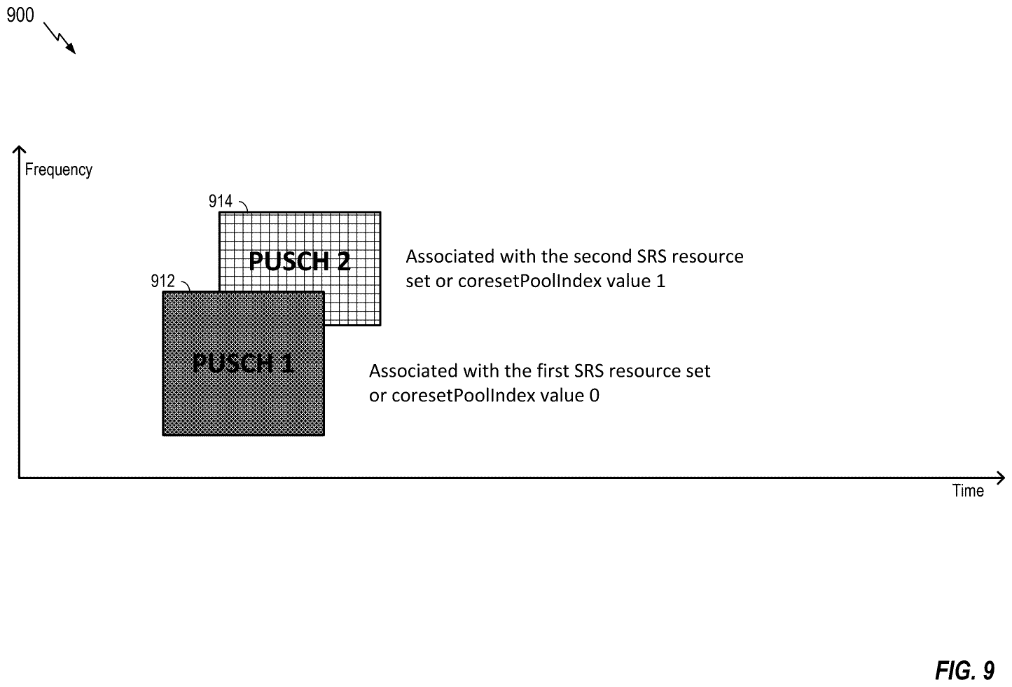

FIG. 9 is an example diagram 900 illustrating two PUSCH transmissions that overlap in the time domain. As shown FIG. 9, a first PUSCH transmission 912 of first PUSCH data may at least partially overlap with a second PUSCH transmission 914 of second PUSCH data in the time domain. The first PUSCH transmission 912 may be scheduled by a first DCI from a first TRP, while the second PUSCH transmission 914 may be scheduled by a second DCI from a second TRP. The first PUSCH transmission 912 may be associated with a first SRS resource set and/or coreset pool index value of 0. The second PUSCH transmission 914 may be associated with the second SRS resource set and/or coreset pool index value of 1.

In an aspect, the UE may indicate UE capabilities related to a maximum number of MIMO layers supported by the UE per CC per band per band combination (per feature set per CC (FSPC)). For downlink, the UE may provide a parameter indicating a maximum number of MIMO layers supported by the UE for a downlink communication.

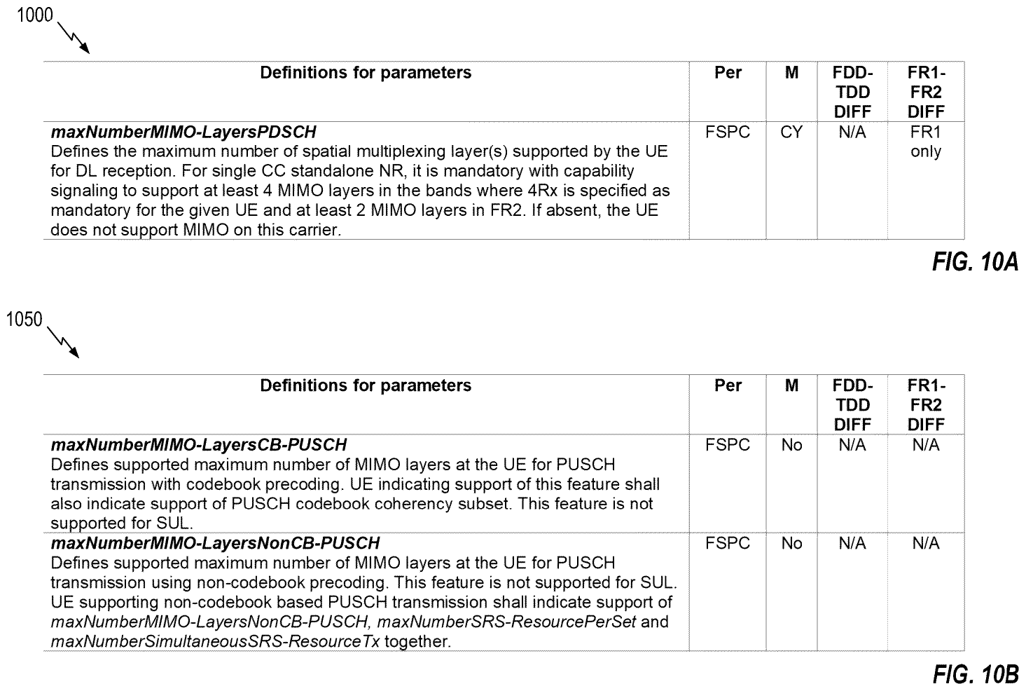

FIG. 10A is a table 1000 showing a parameter defining a maximum number of MIMO layers for a PDSCH. As shown in FIG. 10A, the UE may provide a parameter “maxNumberMIMO-LayersPDSCH” to define the maximum number of spatial multiplexing layer(s) supported by the UE for a downlink reception.

For uplink, the UE may provide a parameter indicating a maximum number of MIMO layers supported by the UE for a CB-based uplink communication. For uplink, the UE may provide a different parameter indicating a maximum number of MIMO layers supported by the UE for an NCB-based uplink communication.

FIG. 10B is a table 1050 showing a parameter defining a maximum number of MIMO layers for a CB-based PUSCH communication and showing a parameter defining a maximum number of MIMO layers for an NCB-based PUSCH communication. As shown in FIG. 10B, the UE may provide a parameter “maxNumberMIMO-LayersCB-PUSCH” to define supported maximum number of MIMO layers at the UE for PUSCH transmission with codebook precoding. FIG. 10B also shows that the UE may provide a parameter “maxNumberMIMO-LayersNonCB-PUSCH” to define supported maximum number of MIMO layers at the UE for PUSCH transmission using non-codebook precoding. The parameters “maxNumberMIMO-LayersCB-PUSCH” and “maxNumberMIMO-LayersNonCB-PUSCH” are further described in 3GPP Technical Specification TS 38.306 on UE radio access capabilities (Release 16). These parameters are legacy parameters for scheduling uplink communication with a single TRP.

In an aspect, for downlink communications from multiple TRPs (with overlapping PDSCHs associated with different coresetPoolIndex values), the following UE capabilities may indicate how to interpret the legacy UE capability parameter “maxNumberMIMO-LayersPDSCH”.

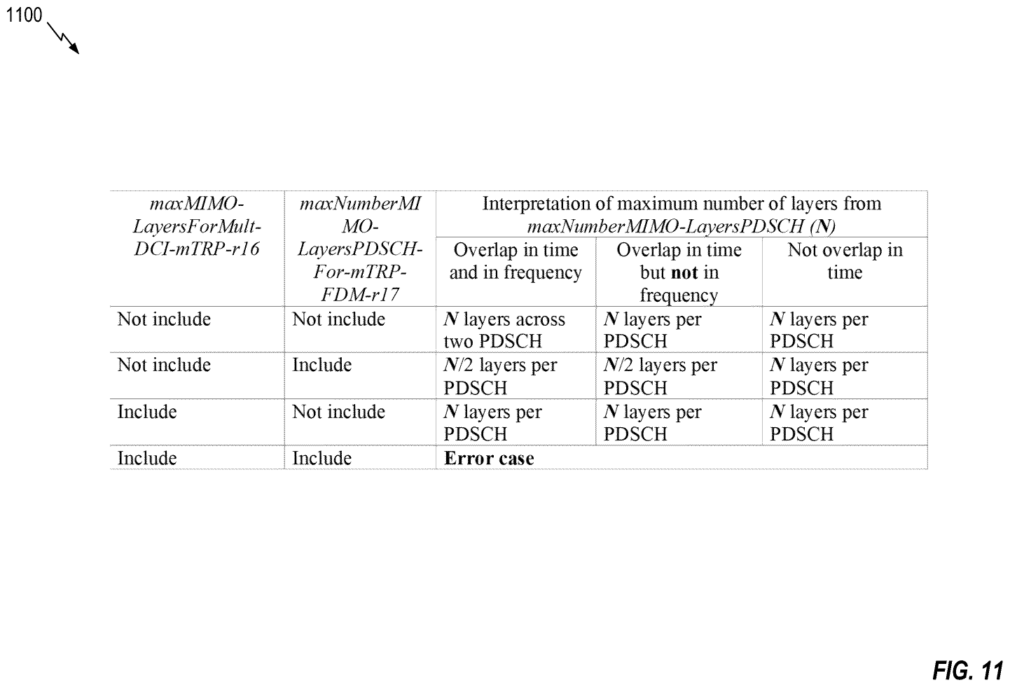

FIG. 11 is a table 1100 showing different interpretation operations depending on a parameter reported by the UE to indicate a maximum number of MIMO layers supported by the UE for downlink in a multiple TRP situation. The legacy UE capability parameter “maxNumberMIMO-LayersPDSCH” may include a number N, which can be interpreted in different ways depending on a parameter reported by the UE. As shown in FIG. 11, if the UE reports maxMIMO-LayersForMulti-DCI-mTRP-r16, then N is interpreted N layers as per TRP (per PDSCH). As shown in FIG. 11, if the UE reports maxNumberMIMO-LayersPDSCH-For-mTRP-FDM-r17, the per TRP (per PDSCH) rank is N/2 layers.

As discussed above, UE capabilities may be reported for downlink communications from multiple TRPs, However, for uplink communications to multiple TRPs, the UE currently does not report the UE capability. In particular, currently, there is no UE capability signaling to report a maximum number of MIMO layers supported by the UE for uplink communications to multiple TRPs.

According to some aspects of the disclosure, a UE (e.g., UE 104, UE 502) may transmit, to multiple TRPs, a layer parameter based on a maximum number of MIMO uplink layers that are supported by the UE for uplink communication with the multiple TRPs, such that a TRP that receives the layer parameter may determine, based on the layer parameter, the maximum number of MIMO uplink layers supported by the UE for uplink communication to the multiple TRPs. Subsequently, the TRP may determine uplink scheduling information based on the maximum number of MIMO uplink layers supported by the UE for uplink communication to the multiple TRPs, and transmit the uplink scheduling information to the UE. In an aspect, the uplink scheduling information may be an uplink grant (e.g., in DCI). The generation of the uplink scheduling information such as the uplink grant is well-known in the art. After receiving the uplink scheduling information, the UE may transmit, to each of the multiple TRPs, a PUSCH communication according to the uplink scheduling information. For example, the uplink scheduling information may indicate how to perform the transmission of the PUSCH communication to each TRP.

According to a first approach of some aspects of the disclosure, the layer parameter may be a legacy parameter for scheduling UL communication with a single TRP, where the legacy parameter is repurposed for scheduling UL communication with the multiple TRPs. For example, the legacy parameter may be maxNumberMIMO-LayersCB-PUSCH for codebook-based communication or maxNumberMIMO-LayersNonCB-PUSCH for non-codebook communication. Hence, when the UE reports the legacy parameter that is used for scheduling UL communication with a single TRP, a TRP receiving the legacy parameter may interpret the legacy parameter for scheduling UL communication with the multiple TRPs. The legacy parameter may be interpreted based on an interpretation parameter specifying which interpretation operation to use in determining the maximum number of MIMO uplink layers based on the legacy parameter. The specified interpretation operation may indicate how to determine a per-TRP maximum number of MIMO uplink layers supported by the UE based on the legacy parameter, where the per-TRP maximum number of MIMO uplink layers is the same for each of the plurality of TRPs. The specified interpretation operation may be either of a first interpretation operation or a second interpretation operation, as described below. Other interpretation operations may be possible as well.

According to the first interpretation operation in the first approach, the per-TRP maximum number of MIMO uplink layers for each of the multiple TRPs is a fraction of the legacy parameter. In an example, if a total number of the multiple TRPs is two, the fraction may be one half. In this example, if the legacy parameter includes 4, the per-TRP maximum number of MIMO uplink layers may be interpreted as 2, which is one half of 4.

In an aspect for SDM, according to the first interpretation operation, the per-TRP maximum number of MIMO uplink layers for each of the multiple TRPs may indicate a maximum number of MIMO uplink layers, per set of uplink layers, that is associated with a respective SRS resource set. Hence, in this aspect, for example, if a total number of the multiple TRPs is two, the maximum number of MIMO uplink layers, per set of uplink layers, is one half of the legacy parameter. Also, in this aspect, a total maximum number of MIMO uplink layers across the multiple TRPs (e.g., all sets of layers) may be the same as the layer parameter.

In an aspect for FDM, according to the first interpretation operation, the per-TRP maximum number of MIMO uplink layers for each of the multiple TRPs may indicate a maximum number of MIMO uplink layers per transmission occasion that is associated with a respective SRS resource set. Hence, in this aspect, for example, if a total number of the multiple TRPs is two, the maximum number of MIMO uplink layers per transmission occasion is one half of the legacy parameter.

In an aspect for time-domain overlapping of multiple PUSCH transmissions, according to the first interpretation operation, the per-TRP maximum number of MIMO uplink layers for each of the plurality of TRPs may indicate a maximum number of MIMO uplink layers per PUSCH transmission that is associated with a respective SRS resource set. Hence, for example, for two time-domain overlapping PUSCH transmissions (e.g., to two respective TRPs), a maximum number of MIMO uplink layers per PUSCH transmission may be one half of the legacy parameter.

According to the second interpretation operation in the first approach, the per-TRP maximum number of MIMO uplink layers for each of the multiple TRPs may be equal to the legacy parameter. For example, if the legacy parameter includes 4, the per-TRP maximum number of MIMO uplink layers may be interpreted as 4.

In an aspect for SDM, according to the second interpretation operation, the per-TRP maximum number of MIMO uplink layers for each of the multiple TRPs indicates a total number of MIMO uplink layers across the multiple TRPs divided by a total number of the multiple TRPs. In this aspect, if a total number of the multiple TRPs is two, a total maximum number of MIMO uplink layers across the multiple TRPs (e.g., all sets of layers) may be the twice the value of the layer parameter.

In an aspect for FDM, according to the second interpretation operation, the per-TRP maximum number of MIMO uplink layers for each of the multiple TRPs indicates a maximum number of MIMO uplink layers per transmission occasion that is associated with a respective SRS resource set for frequency division multiplexing.

In an aspect for time-domain overlapping of multiple PUSCH transmissions, according to the second interpretation operation, the per-TRP maximum number of MIMO uplink layers for each of the multiple TRPs indicates a maximum number of MIMO uplink layers per PUSCH transmission that is associated with a respective SRS resource set for time-domain overlapping.

With regard to the interpretation parameter, in an aspect, the interpretation parameter may be transmitted to the multiple TRPs and/or may be preconfigured or pre-stored at the multiple TRPs. In an example, the interpretation parameter may be transmitted by the UE or another device. Hence, a TRP may receive the interpretation parameter (e.g., from the UE or another device) and/or may retrieve the interpretation parameter within the TRP. Subsequently, the TRP may determine, according to the interpretation operation specified by the interpretation parameter, the maximum number of MIMO uplink layers based on the legacy parameter. In an aspect, the specified interpretation operation may be the same for the SDM, the FDM, and the time-domain overlapping. In another aspect, the specified operation may be different for each of the SDM, the FDM, and the time-domain overlapping. Hence, in an aspect, the legacy interpretation parameter may further include a multiplex-type indicator indicating a type of multiplexing associated with the specified the interpretation operation. For example, the legacy interpretation parameter may specify the first interpretation operation and may include a multiplex-type indicator indicating the SDM, indicating that the first interpretation operation is to be used for the SDM. In an aspect, separate interpretation parameters may be transmitted for CB-based transmissions and NCB-based transmissions.

According to a second approach of some aspects of the disclosure, the layer parameter may be a non-legacy parameter for scheduling uplink communication with the multiple TRPs. The non-legacy parameter may be a newly-introduced parameter that has not been used before. When the UE reports the non-legacy parameter, a TRP receiving the non-legacy parameter may interpret the non-legacy parameter for scheduling UL communication with the multiple TRPs. In an aspect, the UE may generate the non-legacy parameter based on the maximum number of MIMO uplink layers that are supported by the UE for uplink communication, and then transmit the non-legacy parameter to the multiple TRPs. In an aspect, the non-legacy parameter may be based on a per-TRP maximum number of MIMO uplink layers supported by the UE, where the per-TRP maximum number of MIMO uplink layers is the same for each of the plurality of TRPs. When a TRP receives the non-legacy parameter, the TRP may interpret the non-legacy parameter according to at least one of the interpretation operations discussed below.

According to a first interpretation operation of the second approach, the per-TRP maximum number of MIMO uplink layers for each of the multiple TRPs may be equal to a MIMO layer number included in the non-legacy parameter.

In an aspect for the SDM, according to the first interpretation operation, the per-TRP maximum number of MIMO uplink layers for each of the multiple TRPs indicates a maximum number of MIMO uplink layers, per set of uplink layers, that is associated with a respective sounding reference signal (SRS) resource set. For example, when the number of the multiple TRPs is two, there may be two sets of uplink layers that are respectively associated with two SRS resource sets.

In an aspect for the FDM, according to the first interpretation operation, the per-TRP maximum number of MIMO uplink layers for each of the multiple TRPs indicates a maximum number of MIMO uplink layers per transmission occasion that is associated with a respective SRS resource set. For example, when the number of the multiple TRPs is two, there may be two transmission occasions that are respectively associated with two SRS resource sets.

In an aspect for time-domain overlapping of multiple PUSCH transmissions, according to the first interpretation operation, the per-TRP maximum number of MIMO uplink layers for each of the multiple TRPs indicates a maximum number of MIMO uplink layers per PUSCH transmission that is associated with a respective SRS resource set. For example, when the number of the multiple TRPs is two, there may be two PUSCH transmissions that are respectively associated with two SRS resource sets.

According to a second interpretation operation of the second approach, the non-legacy parameter indicates a corresponding maximum number of MIMO uplink layers supported by the UE for each respective TRP of the multiple TRPs. Stated another way, the number of values indicated by the non-legacy parameter according to the second interpretation operation may be equal to the number of the multiple TRPs. Hence, in an example where the PUSCH transmissions are directed toward a first TRP and a second TRP, the non-legacy parameter may indicate two values, including a first maximum number of MIMO uplink layers supported by the UE for the first TRP and a second maximum number of MIMO uplink layers supported by the UE for the second TRP. In some examples, the UE may transmit the non-legacy parameter that includes a list of supported combinations of maximum numbers of MIMO uplink layers for respective TRPs. In the example with the first TRP and the second TRP, the UE may transmit (2,1) and (1,1) to indicate that the supported combinations are a first combination where the first maximum number of MIMO uplink layers for the first TRP is two and the second maximum number of MIMO uplink layers for the second TRP is one and a second combination where the first maximum number of MIMO uplink layers for the first TRP is one and the second maximum number of MIMO uplink layers for the second TRP is also one.

In an aspect for the SDM, according to the second interpretation operation, the corresponding maximum number of MIMO uplink layers for each respective TRP of the multiple TRPs indicates a corresponding maximum number of MIMO uplink layers associated with a respective set of uplink layers of a multiple sets of uplink layers. In this aspect, each set of uplink layers of the multiple sets of uplink layers is respectively associated with a corresponding SRS resource set of a multiple SRS resource sets, where each SRS resource set of the multiple SRS resource sets is respectively associated with a corresponding TRP of the multiple TRPs. Hence, in an example where the PUSCH transmissions are toward a first TRP and a second TRP, the non-legacy parameter may indicate a first maximum number of MIMO uplink layers associated with a first SRS resource set and a second maximum number of MIMO uplink layers associated with a second SRS resource set, where the first SRS resource set is associated with the first TRP and the second SRS resource set is associated with the second TRP.

In an aspect for time-domain overlapping of multiple PUSCH transmissions, according to the second interpretation operation, the corresponding maximum number of MIMO uplink layers for each respective TRP of the multiple TRPs indicates a corresponding maximum number of MIMO uplink layers associated with a respective PUSCH transmission of a multiple PUSCH transmissions. In this aspect, each PUSCH transmission of the multiple PUSCH transmissions is respectively associated with a corresponding SRS resource set of a multiple SRS resource sets, where each SRS resource set of the multiple SRS resource sets is respectively associated with a corresponding TRP of the multiple TRPs. Hence, in an example where the PUSCH transmissions are toward a first TRP and a second TRP, the non-legacy parameter may indicate a first maximum number of MIMO uplink layers associated with a first PUSCH transmission toward the first TRP and a second maximum number of MIMO uplink layers associated with a second PUSCH transmission toward the second TRP, where the first PUSCH transmission is associated with a first SRS resource set that is associated with the first TRP and the second PUSCH transmission is associated with the second SRS resource set that is associated with the second TRP.

According to a third interpretation operation of the second approach, the non-legacy parameter indicates a total maximum number of MIMO uplink layers supported by the UE for all of the multiple TRPs.

In an aspect for the SDM, according to the third interpretation operation, the total maximum number of MIMO uplink layers indicates a total maximum number of MIMO uplink layers associated with a multiple sets of uplink layers for space division multiplexing. In this aspect, each set of layers of the multiple sets of layers is respectively associated with a corresponding SRS set of a multiple SRS resource sets, where each SRS resource set of the multiple SRS resource sets is respectively associated with a corresponding TRP of the multiple TRPs. For example, for the SDM, if there are 2 sets of MIMO uplink layers and the non-legacy parameter indicates the total maximum number of MIMO uplink layers being 4, then this indicates that the total maximum number of MIMO uplink layers across all of the 2 sets of uplink layers may be 4, where the 2 sets of MIMO uplink layers are respectively associated with 2 SRS resource sets.

In an aspect for the FDM, according to the third interpretation operation, the total maximum number of MIMO uplink layers indicates a total maximum number of MIMO uplink layers associated with a multiple transmission occasions for frequency division multiplexing. In this aspect, each transmission occasion of the multiple transmission occasions is respectively associated with a corresponding SRS resource set of a multiple SRS resource sets, where each SRS resource set of the multiple SRS resource sets is respectively associated with a corresponding TRP of the multiple TRPs. For example, for the FDM, if there are 2 transmission occasions and the non-legacy parameter indicates the total maximum number of MIMO uplink layers being 4, then this indicates that the total maximum number of MIMO uplink layers across all of the 2 transmission occasions may be 4, where the 2 transmission occasions are respectively associated with 2 SRS resource sets.

In an aspect for time-domain overlapping of multiple PUSCH transmissions, according to the third interpretation operation, the total maximum number of MIMO uplink layers indicates a total maximum number of MIMO uplink layers associated with a multiple PUSCH transmissions for time-domain overlapping, each PUSCH transmission of the multiple PUSCH transmissions being respectively associated with a corresponding SRS set of a multiple SRS resource sets, each SRS resource set of the multiple SRS resource sets being respectively associated with a corresponding TRP of the multiple TRPs. For example, for the time-domain overlapping, if there are 2 PUSCH transmissions and the non-legacy parameter indicates the total maximum number of MIMO uplink layers being 4, then this indicates that the total maximum number of MIMO uplink layers across all of the 2 PUSCH transmissions may be 4, where the 2 PUSCH transmissions are respectively associated with 2 SRS resource sets.

According to a fourth interpretation operation of the second approach, the non-legacy parameter indicates a per-TRP maximum number of MIMO uplink layers supported by the UE for each of the multiple TRPs, and the non-legacy parameter further indicates a total maximum number of MIMO uplink layers supported by the UE for all of the multiple TRPs. Hence, for example, the non-legacy parameter according to the fourth interpretation of the second approach may include two values, a first value for the per-TRP maximum number of MIMO uplink layers, and a second value for the total maximum number of MIMO uplink layers supported by the UE for all of the multiple TRPs. For example, the layer parameter may include the first value 2, which indicates that the UE may support up to the maximum of 2 MIMO uplink layers per TRP, and may further include the second value 4 indicating that the total maximum number of MIMO uplink layers supported by the UE across all of TRPs is 4.

In some aspects, the UE may transmit a non-legacy interpretation parameter specifying which interpretation operation to use in determining the maximum number of MIMO uplink layers based on the non-legacy parameter. In this aspect, after receiving the non-legacy interpretation parameter, the TRP may determine the uplink scheduling information based on the non-legacy parameter and the non-legacy interpretation parameter. In an aspect, the non-legacy interpretation parameter may further include a multiplex-type indicator indicating a type of multiplexing associated with the specified interpretation operation. For example, the legacy interpretation parameter may specify the first interpretation operation and may include a multiplex-type indicator indicating the SDM, effectively indicating that the first interpretation operation is to be used for the SDM. In an aspect, separate interpretation parameters may be transmitted for CB-based transmissions and NCB-based transmissions.

Other than the number of MIMO uplink layers for PUSCH transmissions, it may be beneficial to report additional information. The additional information to be reported to TRPs may include one or more of the UE capabilities for CB-based or NCB-based, parameters of the two SRS resource sets associated with simultaneous transmissions, parameters related to SRS resource sets such as maximum supported number of SRS resources per SRS resource set and/or across both SRS resource sets, etc.

According to some aspects of the disclosure, the UE may transmit, to the multiple TRPs, an additional parameter indicating one or more of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of SRS resources per SRS resource set of the UE, a total number of SRS resources for all SRS resource sets of the UE, and a channel state information reference signal (CSI-RS) support indication indicative of whether each CSI-RS resource associated with a respective SRS resource set is supported by the UE. In this aspect, after receiving the layer parameter and the additional parameter, the TRP may determine the uplink scheduling information based on the layer parameter and the additional parameter. In an aspect, the additional parameter may further include one or more of: a maximum number of periodic SRS resources associated with first and second CSI-RS resources per bandwidth part (BWP), a maximum number of semi-persistent SRS resources associated with the first and second CSI-RS resource per BWP, and a maximum number of SRS resources associated with the first and second CSI-RS resources that the UE can process simultaneously in a component carrier.

### Example Operations of Entities in a Communications Network

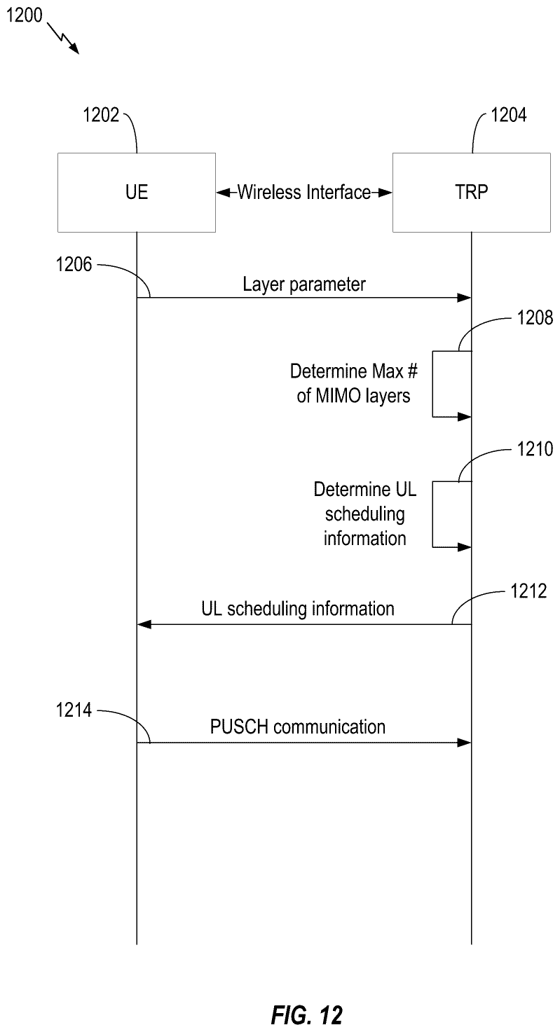

FIG. 12 depicts a process flow 1200 for communications in a network between a user equipment (UE) 1202 and a TRP 1204. In some aspects, the UE 1202 may be an example of UE 104 depicted and described with respect to FIGS. 1 and 3 or an example of UE 502 depicted and described with respect to FIG. 5. In some aspects, the TRP 1204 may be an example of the BS 102 depicted and described with respect to FIGS. 1 and 3 or a disaggregated base station depicted and described with respect to FIG. 2 or one of the TRPs depicted and described with respect to FIG. 5. However, in other aspects, UE 1202 may be another type of wireless communications device and TRP 1204 may be another type of network entity or network node, such as those described herein.

At 1206, the UE 1202 may transmit, to multiple TRPs including the TRP 1204, a layer parameter based on a maximum number of MIMO uplink layers that are supported by the UE 1202 for uplink communication to the multiple TRPs. At 1208, after receiving the layer parameter, the TRP 1204 may determine, based on the layer parameter, the maximum number of MIMO uplink layers supported by the UE for uplink communication to multiple TRPs. At 1210, the TRP 1204 may determine uplink scheduling information based on the maximum number of MIMO uplink layers. At 1212, the TRP 1204 may transmit, and the UE 1202 may receive, the uplink scheduling information. At 1214, the UE 1202 may transmit, and the TRP 1204 may receive, a PUSCH communication according to the uplink scheduling information.

### Example Operations of a User Equipment

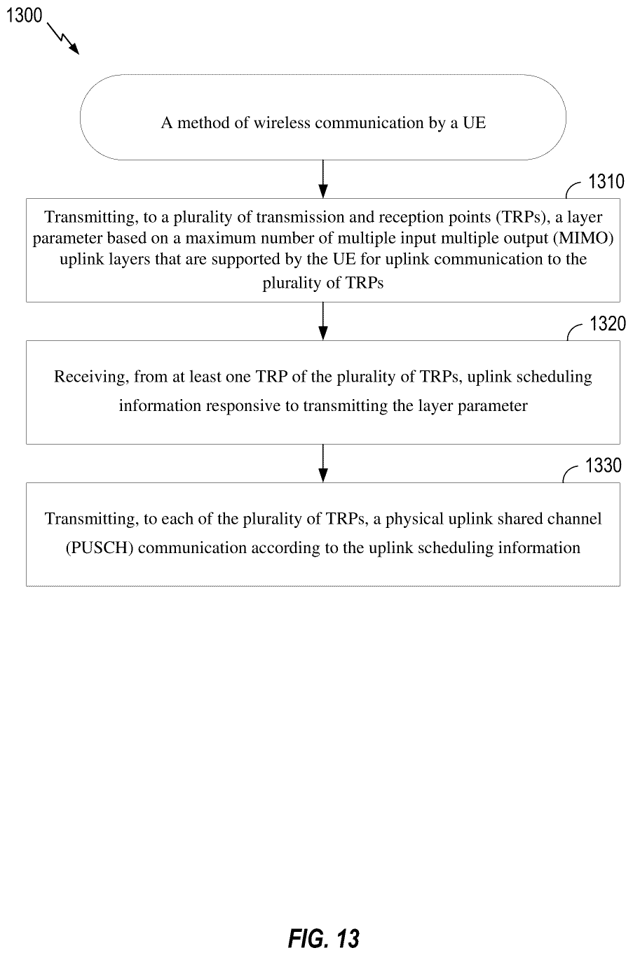

FIG. 13 shows a method 1300 for wireless communications by a UE, such as UE 104 of FIGS. 1 and 3, UE 502 of FIG. 5, or UE 1202 of FIG. 12.

Method 1300 begins at 1310 with transmitting, to a plurality of transmission and reception points (TRPs), a layer parameter based on a maximum number of multiple input multiple output (MIMO) uplink layers that are supported by the UE for uplink communication to the plurality of TRPs.

Method 1300 then proceeds to step 1320 with receiving, from at least one TRP of the plurality of TRPs, uplink scheduling information responsive to transmitting the layer parameter.

Method 1300 then proceeds to step 1330 with transmitting, to each of the plurality of TRPs, a physical uplink shared channel (PUSCH) communication according to the uplink scheduling information.

In one aspect, method 1300 further includes generating the layer parameter based on the maximum number of MIMO uplink layers that are supported by the UE for uplink communication.

In one aspect, the layer parameter is a legacy parameter for scheduling uplink communication with a single TRP, the legacy parameter being repurposed for scheduling uplink communication with the plurality of TRPs. In one aspect, the legacy parameter is maxNumberMIMO-LayersCB-PUSCH for codebook-based communication or maxNumberMIMO-LayersNonCB-PUSCH for non-codebook communication.

In one aspect, method 1300 further includes transmitting a legacy interpretation parameter specifying which interpretation operation to use in determining the maximum number of MIMO uplink layers based on the legacy parameter. In one aspect, the legacy interpretation parameter further includes a multiplex-type indicator indicating a type of multiplexing associated with the specified the interpretation operation.

In one aspect, the specified interpretation operation indicates how to determine a per-TRP maximum number of MIMO uplink layers supported by the UE based on the legacy parameter, the per-TRP maximum number of MIMO uplink layers being the same for each of the plurality of TRPs.

In one aspect, according to the specified interpretation operation, the per-TRP maximum number of MIMO uplink layers for each of the plurality of TRPs is a fraction of the legacy parameter. In one aspect, a total number of the plurality of TRPs is two and the fraction is one half.

In one aspect, according to the specified interpretation operation, the per-TRP maximum number of MIMO uplink layers for each of the plurality of TRPs is equal to the legacy parameter.

In one aspect, the layer parameter is a non-legacy parameter for scheduling uplink communication with the plurality of TRPs.

In one aspect, the non-legacy parameter is based on a per-TRP maximum number of MIMO uplink layers supported by the UE, the per-TRP maximum number of MIMO uplink layers being the same for each of the plurality of TRPs. In one aspect, the per-TRP maximum number of MIMO uplink layers for each of the plurality of TRPs is equal to the non-legacy parameter. In one aspect, the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing. In one aspect, the per-TRP maximum number of MIMO uplink layers for each of the plurality of TRPs indicates a maximum number of MIMO uplink layers per transmission occasion that is associated with a respective SRS resource set for frequency division multiplexing. In one aspect, the per-TRP maximum number of MIMO uplink layers for each of the plurality of TRPs indicates a maximum number of MIMO uplink layers per PUSCH transmission that is associated with a respective SRS resource set for time-domain overlapping.

In one aspect, the non-legacy parameter indicates a corresponding maximum number of MIMO uplink layers supported by the UE for each respective TRP of the plurality of TRPs. In one aspect, the corresponding maximum number of MIMO uplink layers for each respective TRP of the plurality of TRPs indicates a corresponding maximum number of MIMO uplink layers associated with a respective set of uplink layers of a plurality of sets of uplink layers for space division multiplexing, each set of uplink layers of the plurality of sets of uplink layers being respectively associated with a corresponding sounding reference signal (SRS) resource set of a plurality of SRS resource sets, each SRS resource set of the plurality of SRS resource sets being respectively associated with a corresponding TRP of the plurality of TRPs. In one aspect, the corresponding maximum number of MIMO uplink layers for each respective TRP of the plurality of TRPs indicates a corresponding maximum number of MIMO uplink layers associated with a respective PUSCH transmission of a plurality of PUSCH transmissions for time-domain overlapping, each PUSCH transmission of the plurality of PUSCH transmissions being respectively associated with a corresponding sounding reference signal (SRS) resource set of a plurality of SRS resource sets, each SRS resource set of the plurality of SRS resource sets being respectively associated with a corresponding TRP of the plurality of TRPs.

In one aspect, the non-legacy parameter indicates a total maximum number of MIMO uplink layers supported by the UE for all of the plurality of TRPs. In one aspect, the total maximum number of MIMO uplink layers indicates a total maximum number of MIMO uplink layers associated with a plurality of sets of uplink layers for space division multiplexing, each set of uplink layers of the plurality of sets of uplink layers being respectively associated with a corresponding sounding reference signal (SRS) set of a plurality of SRS resource sets, each SRS resource set of the plurality of SRS resource sets being respectively associated with a corresponding TRP of the plurality of TRPs. In one aspect, the total maximum number of MIMO uplink layers indicates a total maximum number of MIMO uplink layers associated with a plurality of transmission occasions for frequency division multiplexing, each transmission occasion of the plurality of transmission occasions being respectively associated with a corresponding sounding reference signal (SRS) set of a plurality of SRS resource sets, each SRS resource set of the plurality of SRS resource sets being respectively associated with a corresponding TRP of the plurality of TRPs. In one aspect, the total maximum number of MIMO uplink layers indicates a total maximum number of MIMO uplink layers associated with a plurality of PUSCH transmissions for time-domain overlapping, each PUSCH transmission of the plurality of PUSCH transmissions being respectively associated with a corresponding sounding reference signal (SRS) set of a plurality of SRS resource sets, each SRS resource set of the plurality of SRS resource sets being respectively associated with a corresponding TRP of the plurality of TRPs.

In one aspect, the non-legacy parameter indicates a per-TRP maximum number of MIMO uplink layers supported by the UE for each of the plurality of TRPs, and the non-legacy parameter further indicates a total maximum number of MIMO uplink layers supported by the UE for all of the plurality of TRPs.

In one aspect, method 1300 further includes transmitting a non-legacy interpretation parameter specifying which interpretation operation to use in determining the maximum number of MIMO uplink layers based on the non-legacy parameter. In one aspect, the non-legacy interpretation parameter further includes a multiplex-type indicator indicating a type of multiplexing associated with the specified the interpretation operation.

In one aspect, method 1300 further includes transmitting an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE. In one aspect, the additional parameter further comprises at least one of: a maximum number of periodic SRS resources associated with first and second CSI-RS resources per bandwidth part (BWP), a maximum number of semi-persistent SRS resources associated with the first and second CSI-RS resource per BWP, or a maximum number of SRS resources associated with the first and second CSI-RS resources that the UE can process simultaneously in a component carrier.

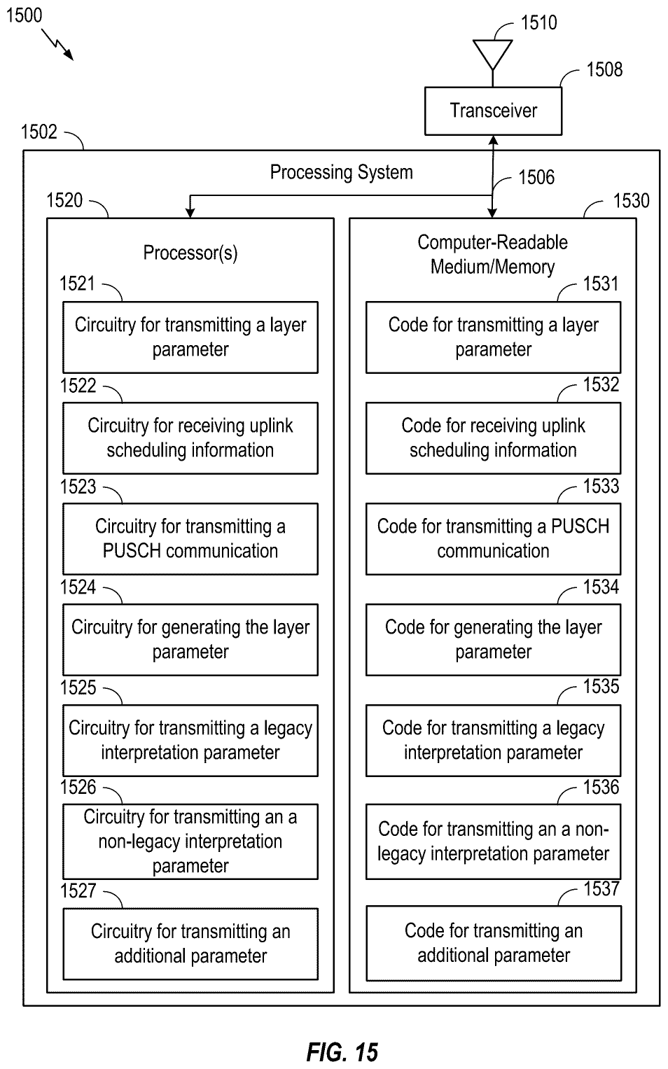

In one aspect, method 1300, or any aspect related to it, may be performed by an apparatus, such as communications device 1500 of FIG. 15, which includes various components operable, configured, or adapted to perform the method 1300. Communications device 1500 is described below in further detail.

Note that FIG. 13 is just one example of a method, and other methods including fewer, additional, or alternative steps are possible consistent with this disclosure.

### Example Operations of a Network Entity

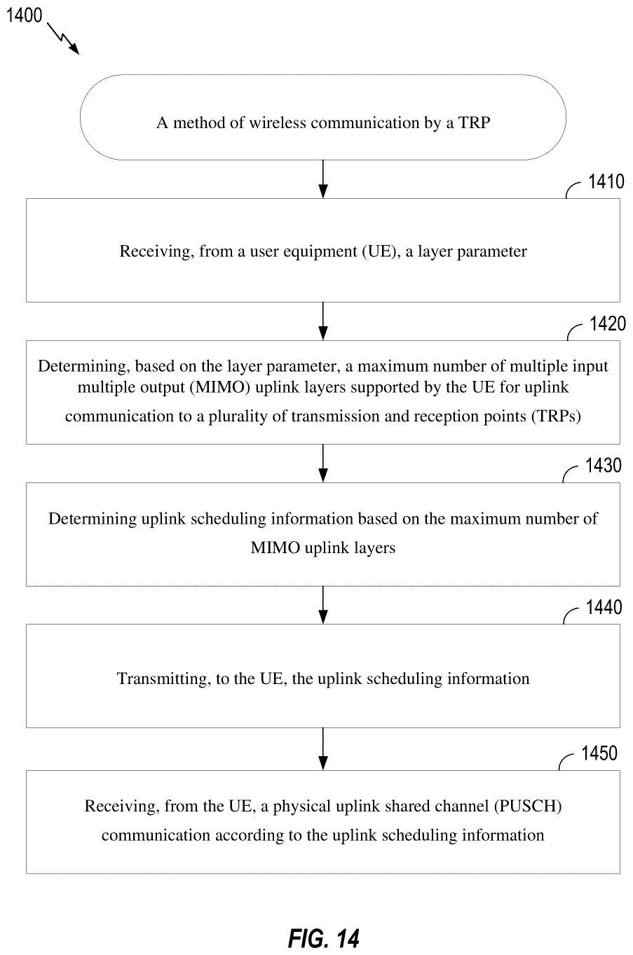

FIG. 14 shows a method 1400 for wireless communications by a network entity, such as BS 102 of FIGS. 1 and 3, or a disaggregated base station as discussed with respect to FIG. 2, a TRP 542 of FIG. 5, or TRP 1204 of FIG. 12.

Method 1400 begins at 1410 with receiving, from a user equipment (UE), a layer parameter.

Method 1400 then proceeds to step 1420 with determining, based on the layer parameter, a maximum number of multiple input multiple output (MIMO) uplink layers supported by the UE for uplink communication to a plurality of transmission and reception points (TRPs).

Method 1400 then proceeds to step 1430 with determining uplink scheduling information based on the maximum number of MIMO uplink layers.

Method 1400 then proceeds to step 1440 with transmitting, to the UE, the uplink scheduling information.

Method 1400 then proceeds to step 1450 with receiving, from the UE, a physical uplink shared channel (PUSCH) communication according to the uplink scheduling information.

In one aspect, the layer parameter is a legacy parameter for scheduling uplink communication with a single TRP, the legacy parameter being repurposed for scheduling uplink communication with the plurality of TRPs. In one aspect, the legacy parameter is a maxNumberMIMO-LayersCB-PUSCH for codebook-based communication or maxNumberMIMO-LayersNonCB-PUSCH for non-codebook communication.

In one aspect, the determining the maximum number of MIMO uplink layers at 1420 comprises determining the maximum number of MIMO uplink layers based on the legacy parameter and further based on a legacy interpretation parameter, the legacy interpretation parameter specifying which interpretation operation to use in determining the maximum number of MIMO uplink layers based on the legacy parameter.

In one aspect, the legacy interpretation parameter further includes a multiplex-type indicator indicating a type of multiplexing associated with the specified interpretation operation.

In one aspect, method 1400 further includes receiving, from the UE, the legacy interpretation parameter.

In one aspect, the legacy interpretation parameter is preconfigured at the TRP.

In one aspect, the determining the maximum number of MIMO uplink layers based on the layer parameter at 1420 comprises determining, according to the specified interpretation operation, a per-TRP maximum number of MIMO uplink layers supported by the UE based on the legacy parameter, the per-TRP maximum number of MIMO uplink layers being the same for each of the plurality of TRPs.

In one aspect, according to the specified interpretation operation, the per-TRP maximum number of MIMO uplink layers for each of the plurality of TRPs is a fraction of the legacy parameter. In one aspect, a total number of the plurality of TRPs is two and the fraction is one half.

In one aspect, according to the specified interpretation operation, the per-TRP maximum number of MIMO uplink layers for each of the plurality of TRPs is equal to the legacy parameter.

In one aspect, according to the specified interpretation operation, the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing.

In one aspect, according to the specified interpretation operation the per-TRP maximum number of MIMO uplink layers for each of the plurality of TRPs indicates a total number of MIMO uplink layers across the plurality of TRPs divided by a total number of the plurality of TRPs for space division multiplexing.

In one aspect, according to the specified interpretation operation, the per-TRP maximum number of MIMO uplink layers for each of the plurality of TRPs indicates a maximum number of MIMO uplink layers per transmission occasion that is associated with a respective SRS resource set for frequency division multiplexing.

In one aspect, according to the specified interpretation operation, the per-TRP maximum number of MIMO uplink layers for each of the plurality of TRPs indicates a maximum number of MIMO uplink layers per PUSCH transmission that is associated with a respective SRS resource set for time-domain overlapping.

In one aspect, the layer parameter is a non-legacy parameter for scheduling uplink communication with the plurality of TRPs.

In one aspect, the determining the maximum number of MIMO uplink layers based on the layer parameter at 1420 comprises determining a per-TRP maximum number of MIMO uplink layers supported by the UE based on the non-legacy parameter, the per-TRP maximum number of MIMO uplink layers being the same for each of the plurality of TRPs.

In one aspect, the per-TRP maximum number of MIMO uplink layers for each of the plurality of TRPs is equal to a MIMO layer number included in the non-legacy parameter.

In one aspect, the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing.

In one aspect, the per-TRP maximum number of MIMO uplink layers for each of the plurality of TRPs indicates a maximum number of MIMO uplink layers per transmission occasion that is associated with a respective SRS resource set for frequency division multiplexing.

In one aspect, the per-TRP maximum number of MIMO uplink layers for each of the plurality of TRPs indicates a maximum number of MIMO uplink layers per PUSCH transmission that is associated with a respective SRS resource set for time-domain overlapping.

In one aspect, the non-legacy parameter indicates a corresponding maximum number of MIMO uplink layers supported by the UE for each respective TRP of the plurality of TRPs.

In one aspect, the corresponding maximum number of MIMO uplink layers for each respective TRP of the plurality of TRPs indicates a corresponding maximum number of MIMO uplink layers associated with a respective set of uplink layers of a plurality of sets of uplink layers for space division multiplexing, each set of uplink layers of the plurality of sets of uplink layers being respectively associated with a corresponding sounding reference signal (SRS) resource set of a plurality of SRS resource sets, each SRS resource set of the plurality of SRS resource sets being respectively associated with a corresponding TRP of the plurality of TRPs.

In one aspect, the corresponding maximum number of MIMO uplink layers for each respective TRP of the plurality of TRPs indicates a corresponding maximum number of MIMO uplink layers associated with a respective PUSCH transmission of a plurality of PUSCH transmissions for time-domain overlapping, each PUSCH transmission of the plurality of PUSCH transmissions being respectively associated with a corresponding sounding reference signal (SRS) resource set of a plurality of SRS resource sets, each SRS resource set of the plurality of SRS resource sets being respectively associated with a corresponding TRP of the plurality of TRPs.

In one aspect, the non-legacy parameter indicates a total maximum number of MIMO uplink layers supported by the UE for all of the plurality of TRPs.

In one aspect, the total maximum number of MIMO uplink layers indicates a total maximum number of MIMO uplink layers associated with a plurality of sets of uplink layers for space division multiplexing, each set of uplink layers of the plurality of sets of uplink layers being respectively associated with a corresponding sounding reference signal (SRS) set of a plurality of SRS resource sets, each SRS resource set of the plurality of SRS resource sets being respectively associated with a corresponding TRP of the plurality of TRPs.

In one aspect, the total maximum number of MIMO uplink layers indicates a total maximum number of MIMO uplink layers associated with a plurality of transmission occasions for frequency division multiplexing, each transmission occasion of the plurality of transmission occasions being respectively associated with a corresponding sounding reference signal (SRS) resource set of a plurality of SRS resource sets, each SRS resource set of the plurality of SRS resource sets being respectively associated with a corresponding TRP of the plurality of TRPs.

In one aspect, the total maximum number of MIMO uplink layers indicates a total maximum number of MIMO uplink layers associated with a plurality of PUSCH transmissions for time-domain overlapping, each PUSCH transmission of the plurality of PUSCH transmissions being respectively associated with a corresponding sounding reference signal (SRS) set of a plurality of SRS resource sets, each SRS resource set of the plurality of SRS resource sets being respectively associated with a corresponding TRP of the plurality of TRPs.

In one aspect, the non-legacy parameter indicates a per-TRP maximum number of MIMO uplink layers supported by the UE for each of the plurality of TRPs, and the non-legacy parameter further indicates a total maximum number of MIMO uplink layers supported by the UE for all of the plurality of TRPs.

In one aspect, method 1400 further includes receiving, from the UE, a non-legacy interpretation parameter specifying which interpretation operation to use in determining the maximum number of MIMO uplink layers based on the non-legacy parameter, where the determining the uplink scheduling information at 1430 comprises determining the uplink scheduling information based on the non-legacy parameter and the non-legacy interpretation parameter. In one aspect, the non-legacy interpretation parameter further includes a multiplex-type indicator indicating a type of multiplexing associated with the specified interpretation operation.

In one aspect, method 1400 further includes receiving, from the UE, an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE, where the determining uplink scheduling information comprises determining the uplink scheduling information at 1430 based on the layer parameter and the additional parameter. In one aspect, the additional parameter further comprises at least one of: a maximum number of periodic SRS resources associated with first and second CSI-RS resources per bandwidth part (BWP), a maximum number of semi-persistent SRS resources associated with the first and second CSI-RS resource per BWP, or a maximum number of SRS resources associated with the first and second CSI-RS resources that the UE can process simultaneously in a component carrier

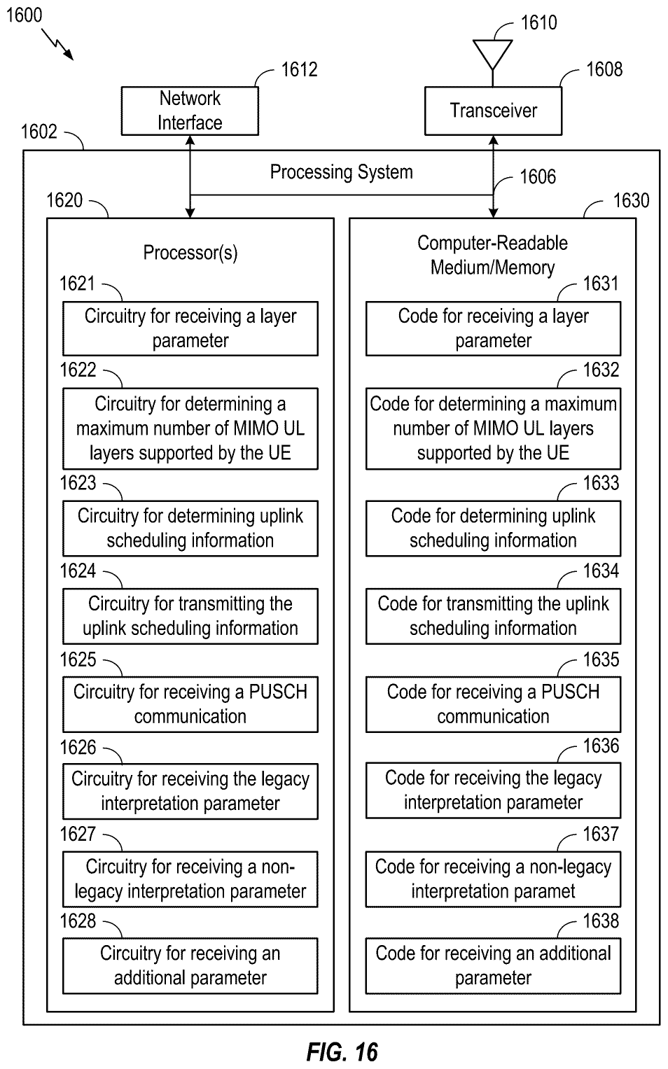

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

### Example Communications Devices

FIG. 15 depicts aspects of an example communications device 1500. In some aspects, communications device 1500 is a user equipment, such as UE 104 described above with respect to FIGS. 1 and 3, or UE 502 of FIG. 5, or UE 1202 of FIG. 12.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 358, transmit processor 364, TX MIMO processor 366, and/or controller/processor 380, as described with respect to FIG. 3. The one or more processors 1520 are coupled to a computer-readable medium/memory 1530 via a bus 1506. In certain aspects, the computer-readable medium/memory 1530 is configured to store instructions (e.g., computer-executable code) that when executed by the one or more processors 1520, cause the one or more processors 1520 to perform the method 1300 described with respect to FIG. 13, or any aspect related to it. Note that reference to a processor performing a function of communications device 1500 may include one or more processors performing that function of communications device 1500.

In the depicted example, computer-readable medium/memory 1530 stores code (e.g., executable instructions) for transmitting, to a plurality of transmission and reception points (TRPs), a layer parameter based on a maximum number of multiple input multiple output (MIMO) uplink layers that are supported by the UE for uplink communication to the plurality of TRPs 1531, code for receiving, from at least one TRP of the plurality of TRPs, uplink scheduling information responsive to transmitting the layer parameter 1532, code for transmitting, to each of the plurality of TRPs, a physical uplink shared channel (PUSCH) communication according to the uplink scheduling information 1533, code for generating the layer parameter based on the maximum number of MIMO uplink layers that are supported by the UE for uplink communication 1534, code for transmitting a legacy interpretation parameter specifying which interpretation operation to use in determining the maximum number of MIMO uplink layers based on the legacy parameter 1535, code for transmitting a non-legacy interpretation parameter specifying which interpretation operation to use in determining the maximum number of MIMO uplink layers based on the non-legacy parameter 1536, and code for transmitting an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE 1537. Processing of the code 1531-1537 may cause the communications device 1500 to perform the method 1300 described with respect to FIG. 13, or any aspect related to it.

The one or more processors 1520 include circuitry configured to implement (e.g., execute) the code stored in the computer-readable medium/memory 1530, including circuitry for transmitting, to a plurality of transmission and reception points (TRPs), a layer parameter based on a maximum number of multiple input multiple output (MIMO) uplink layers that are supported by the UE for uplink communication to the plurality of TRPs 1521, circuitry for receiving, from at least one TRP of the plurality of TRPs, uplink scheduling information responsive to transmitting the layer parameter 1522, circuitry for transmitting, to each of the plurality of TRPs, a physical uplink shared channel (PUSCH) communication according to the uplink scheduling information 1523, circuitry for generating the layer parameter based on the maximum number of MIMO uplink layers that are supported by the UE for uplink communication 1524, circuitry for transmitting a legacy interpretation parameter specifying which interpretation operation to use in determining the maximum number of MIMO uplink layers based on the legacy parameter 1525, circuitry for transmitting a non-legacy interpretation parameter specifying which interpretation operation to use in determining the maximum number of MIMO uplink layers based on the non-legacy parameter 1526, and circuitry for transmitting an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE 1527. Processing with circuitry 1521-1527 may cause the communications device 1500 to perform the method 1300 described with respect to FIG. 13, or any aspect related to it.

Various components of the communications device 1500 may provide means for performing the method 1300 described with respect to FIG. 13, or any aspect related to it. For example, means for transmitting, sending or outputting for transmission may include the transceivers 354 and/or antenna(s) 352 of the UE 104 illustrated in FIG. 3 and/or transceiver 1508 and antenna 1510 of the communications device 1500 in FIG. 15. Means for receiving or obtaining may include the transceivers 354 and/or antenna(s) 352 of the UE 104 illustrated in FIG. 3 and/or transceiver 1508 and antenna 1510 of the communications device 1500 in FIG. 15.

FIG. 16 depicts aspects of an example communications device. In some aspects, communications device 1600 is a network entity, such as BS 102 of FIGS. 1 and 3, or a disaggregated base station as discussed with respect to FIG. 2, or a TRP 542 of FIG. 5, or a TRP 1204 of FIG. 12.

The communications device 1600 includes a processing system 1602 coupled to a transceiver 1608 (e.g., a transmitter and/or a receiver) and/or a network interface 1612. The transceiver 1608 is configured to transmit and receive signals for the communications device 1600 via an antenna 1610, such as the various signals as described herein. The network interface 1612 is configured to obtain and send signals for the communications device 1600 via communications link(s), such as a backhaul link, midhaul link, and/or fronthaul link as described herein, such as with respect to FIG. 2. The processing system 1602 may be configured to perform processing functions for the communications device 1600, including processing signals received and/or to be transmitted by the communications device 1600.

The processing system 1602 includes one or more processors 1620. In various aspects, one or more processors 1620 may be representative of one or more of receive processor 338, transmit processor 320, TX MIMO processor 330, and/or controller/processor 340, as described with respect to FIG. 3. The one or more processors 1620 are coupled to a computer-readable medium/memory 1630 via a bus 1606. In certain aspects, the computer-readable medium/memory 1630 is configured to store instructions (e.g., computer-executable code) that when executed by the one or more processors 1620, cause the one or more processors 1620 to perform the method 1400 described with respect to FIG. 14, or any aspect related to it. Note that reference to a processor of communications device 1600 performing a function may include one or more processors of communications device 1600 performing that function.

In the depicted example, the computer-readable medium/memory 1630 stores code (e.g., executable instructions) for receiving, from a user equipment (UE), a layer parameter 1631, code for determining, based on the layer parameter, a maximum number of multiple input multiple output (MIMO) uplink layers supported by the UE for uplink communication to a plurality of transmission and reception points (TRPs) 1632, code for determining uplink scheduling information based on the maximum number of MIMO uplink layers 1633, code for transmitting, to the UE, the uplink scheduling information 1634, code for receiving, from the UE, a physical uplink shared channel (PUSCH) communication according to the uplink scheduling information 1635, code for receiving, from the UE, the legacy interpretation parameter 1636, code for receiving, from the UE, a non-legacy interpretation parameter specifying which interpretation operation to use in determining the maximum number of MIMO uplink layers based on the non-legacy parameter 1637, and code for receiving, from the UE, an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE, where the determining uplink scheduling information comprises determining the uplink scheduling information at 1430 based on the layer parameter and the additional parameter 1638. Processing of the code 1631-1638 may cause the communications device 1600 to perform the method 1400 described with respect to FIG. 14, or any aspect related to it.

The one or more processors 1620 include circuitry configured to implement (e.g., execute) the code stored in the computer-readable medium/memory 1630, including circuitry for receiving, from a user equipment (UE), a layer parameter 1621, circuitry for determining, based on the layer parameter, a maximum number of multiple input multiple output (MIMO) uplink layers supported by the UE for uplink communication to a plurality of transmission and reception points (TRPs) 1622, circuitry for determining uplink scheduling information based on the maximum number of MIMO uplink layers 1623, circuitry for transmitting, to the UE, the uplink scheduling information 1624, circuitry for receiving, from the UE, a physical uplink shared channel (PUSCH) communication according to the uplink scheduling information 1625, circuitry for receiving, from the UE, the legacy interpretation parameter 1626, circuitry for receiving, from the UE, a non-legacy interpretation parameter specifying which interpretation operation to use in determining the maximum number of MIMO uplink layers based on the non-legacy parameter 1627, and circuitry for receiving, from the UE, an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE, where the determining uplink scheduling information comprises determining the uplink scheduling information at 1430 based on the layer parameter and the additional parameter 1628. Processing with circuitry 1621-1628 may cause the communications device 1600 to perform the method 1400 as described with respect to FIG. 14, or any aspect related to it.

Various components of the communications device 1600 may provide means for performing the method 1400 as described with respect to FIG. 14, or any aspect related to it. Means for transmitting, sending or outputting for transmission may include the transceivers 332 and/or antenna(s) 334 of the BS 102 illustrated in FIG. 3 and/or transceiver 1608 and antenna 1610 of the communications device 1600 in FIG. 16. Means for receiving or obtaining may include the transceivers 332 and/or antenna(s) 334 of the BS 102 illustrated in FIG. 3 and/or transceiver 1608 and antenna 1610 of the communications device 1600 in FIG. 16.

### Example Clauses

Implementation examples are described in the following numbered clauses:

Clause 1: A method of wireless communication by a user equipment (UE), comprising: transmitting, to a plurality of transmission and reception points (TRPs), a layer parameter based on a maximum number of multiple input multiple output (MIMO) uplink layers that are supported by the UE for uplink communication to the plurality of TRPs; receiving, from at least one TRP of the plurality of TRPs, uplink scheduling information responsive to transmitting the layer parameter; and transmitting, to each of the plurality of TRPs, a physical uplink shared channel (PUSCH) communication according to the uplink scheduling information.

Clause 2: The method of Clause 1, further comprising: generating the layer parameter based on the maximum number of MIMO uplink layers that are supported by the UE for uplink communication.

Clause 3: The method of Clause 1, wherein the layer parameter is a legacy parameter for scheduling uplink communication with a single TRP, the legacy parameter being repurposed for scheduling uplink communication with the plurality of TRPs.

Clause 4: The method of Clause 3, wherein the legacy parameter is maxNumberMIMO-LayersCB-PUSCH for codebook-based communication or maxNumberMIMO-LayersNonCB-PUSCH for non-codebook communication.

Clause 5: The method of Clause 3 or 4, further comprising: transmitting a legacy interpretation parameter specifying which interpretation operation to use in determining the maximum number of MIMO uplink layers based on the legacy parameter.

Clause 6: The method of Clause 5, wherein the legacy interpretation parameter further includes a multiplex-type indicator indicating a type of multiplexing associated with the specified the interpretation operation.

Clause 7: The method of Clause 5 or 6, wherein the specified interpretation operation indicates how to determine a per-TRP maximum number of MIMO uplink layers supported by the UE based on the legacy parameter, the per-TRP maximum number of MIMO uplink layers being the same for each of the plurality of TRPs.

Clause 8: The method of Clause 7, wherein, according to the specified interpretation operation, the per-TRP maximum number of MIMO uplink layers for each of the plurality of TRPs is a fraction of the legacy parameter.

Clause 9: The method of Clause 8, wherein a total number of the plurality of TRPs is two and the fraction is one half.

Clause 10: The method of Clause 7, wherein, according to the specified interpretation operation, the per-TRP maximum number of MIMO uplink layers for each of the plurality of TRPs is equal to the legacy parameter.

Clause 11: The method of Clause 1, wherein the layer parameter is a non-legacy parameter for scheduling uplink communication with the plurality of TRPs.

Clause 12: The method of Clause 11, wherein the non-legacy parameter is based on a per-TRP maximum number of MIMO uplink layers supported by the UE, the per-TRP maximum number of MIMO uplink layers being the same for each of the plurality of TRPs.

Clause 13: The method of Clause 12, wherein the per-TRP maximum number of MIMO uplink layers for each of the plurality of TRPs is equal to the non-legacy parameter.

Clause 14: The method of Clause 12, wherein the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing.

Clause 15: The method of any of Clauses 12, wherein the per-TRP maximum number of MIMO uplink layers for each of the plurality of TRPs indicates a maximum number of MIMO uplink layers per transmission occasion that is associated with a respective SRS resource set for frequency division multiplexing.

Clause 16: The method of Clause 12, wherein the per-TRP maximum number of MIMO uplink layers for each of the plurality of TRPs indicates a maximum number of MIMO uplink layers per PUSCH transmission that is associated with a respective SRS resource set for time-domain overlapping.

Clause 17: The method of Clause 11, wherein the non-legacy parameter indicates a corresponding maximum number of MIMO uplink layers supported by the UE for each respective TRP of the plurality of TRPs.

Clause 18: The method of Clause 17, wherein the corresponding maximum number of MIMO uplink layers for each respective TRP of the plurality of TRPs indicates a corresponding maximum number of MIMO uplink layers associated with a respective set of uplink layers of a plurality of sets of uplink layers for space division multiplexing, each set of uplink layers of the plurality of sets of uplink layers being respectively associated with a corresponding sounding reference signal (SRS) resource set of a plurality of SRS resource sets, each SRS resource set of the plurality of SRS resource sets being respectively associated with a corresponding TRP of the plurality of TRPs.

Clause 19: The method of Clause 17, wherein the corresponding maximum number of MIMO uplink layers for each respective TRP of the plurality of TRPs indicates a corresponding maximum number of MIMO uplink layers associated with a respective PUSCH transmission of a plurality of PUSCH transmissions for time-domain overlapping, each PUSCH transmission of the plurality of PUSCH transmissions being respectively associated with a corresponding sounding reference signal (SRS) resource set of a plurality of SRS resource sets, each SRS resource set of the plurality of SRS resource sets being respectively associated with a corresponding TRP of the plurality of TRPs.

Clause 20: The method of Clause 11, wherein the non-legacy parameter indicates a total maximum number of MIMO uplink layers supported by the UE for all of the plurality of TRPs.

Clause 21: The method of Clause 20, wherein the total maximum number of MIMO uplink layers indicates a total maximum number of MIMO uplink layers associated with a plurality of sets of uplink layers for space division multiplexing, each set of uplink layers of the plurality of sets of uplink layers being respectively associated with a corresponding sounding reference signal (SRS) set of a plurality of SRS resource sets, each SRS resource set of the plurality of SRS resource sets being respectively associated with a corresponding TRP of the plurality of TRPs.

Clause 22: The method of Clause 20, wherein the total maximum number of MIMO uplink layers indicates a total maximum number of MIMO uplink layers associated with a plurality of transmission occasions for frequency division multiplexing, each transmission occasion of the plurality of transmission occasions being respectively associated with a corresponding sounding reference signal (SRS) set of a plurality of SRS resource sets, each SRS resource set of the plurality of SRS resource sets being respectively associated with a corresponding TRP of the plurality of TRPs.

Clause 23: The method of any of Clause 20, wherein the total maximum number of MIMO uplink layers indicates a total maximum number of MIMO uplink layers associated with a plurality of PUSCH transmissions for time-domain overlapping, each PUSCH transmission of the plurality of PUSCH transmissions being respectively associated with a corresponding sounding reference signal (SRS) set of a plurality of SRS resource sets, each SRS resource set of the plurality of SRS resource sets being respectively associated with a corresponding TRP of the plurality of TRPs.

Clause 24: The method of Clause 11: wherein the non-legacy parameter indicates a per-TRP maximum number of MIMO uplink layers supported by the UE for each of the plurality of TRPs, and wherein the non-legacy parameter further indicates a total maximum number of MIMO uplink layers supported by the UE for all of the plurality of TRPs.

Clause 25: The method of any of Clauses 11 through 24, further comprising: transmitting a non-legacy interpretation parameter specifying which interpretation operation to use in determining the maximum number of MIMO uplink layers based on the non-legacy parameter.

Clause 26: The method of Clause 25, wherein the non-legacy interpretation parameter further includes a multiplex-type indicator indicating a type of multiplexing associated with the specified the interpretation operation.

Clause 27: The method of any of Clauses 1 through 26, further comprising: transmitting an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE.

Clause 28: The method of Clause 27, wherein the additional parameter further comprises at least one of: a maximum number of periodic SRS resources associated with first and second CSI-RS resources per bandwidth part (BWP), a maximum number of semi-persistent SRS resources associated with the first and second CSI-RS resource per BWP, or a maximum number of SRS resources associated with the first and second CSI-RS resources that the UE can process simultaneously in a component carrier.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

Clause 33. A method of wireless communication by a transmission and reception point (TRP), comprising: receiving, from a user equipment (UE), a layer parameter; determining, based on the layer parameter, a maximum number of multiple input multiple output (MIMO) uplink layers supported by the UE for uplink communication to a plurality of transmission and reception points (TRPs); determining uplink scheduling information based on the maximum number of MIMO uplink layers; transmitting, to the UE, the uplink scheduling information; and receiving, from the UE, a physical uplink shared channel (PUSCH) communication according to the uplink scheduling information.

Clause 34. The method of Clause 33, wherein the layer parameter is a legacy parameter for scheduling uplink communication with a single TRP, the legacy parameter being repurposed for scheduling uplink communication with the plurality of TRPs.

Clause 35. The method of Clause 34, wherein the legacy parameter is a maxNumberMIMO-LayersCB-PUSCH for codebook-based communication or maxNumberMIMO-LayersNonCB-PUSCH for non-codebook communication.

Clause 36. The method of Clause 34 or 35, wherein the determining the maximum number of MIMO uplink layers comprises determining the maximum number of MIMO uplink layers based on the legacy parameter and further based on a legacy interpretation parameter, the legacy interpretation parameter specifying which interpretation operation to use in determining the maximum number of MIMO uplink layers based on the legacy parameter.

Clause 37. The method of Clause 36, wherein the legacy interpretation parameter further includes a multiplex-type indicator indicating a type of multiplexing associated with the specified interpretation operation.

Clause 38. The method of Clause 36 or 37, further comprising: receiving, from the UE, the legacy interpretation parameter.

Clause 39. The method of Clause 36 or 37, wherein the legacy interpretation parameter is preconfigured at the TRP.

Clause 40. The method of any of Clauses 36 through 39, wherein the determining the maximum number of MIMO uplink layers based on the layer parameter comprises determining, according to the specified interpretation operation, a per-TRP maximum number of MIMO uplink layers supported by the UE based on the legacy parameter, the per-TRP maximum number of MIMO uplink layers being the same for each of the plurality of TRPs.

Clause 41. The method of Clause 40, wherein, according to the specified interpretation operation, the per-TRP maximum number of MIMO uplink layers for each of the plurality of TRPs is a fraction of the legacy parameter.

Clause 42. The method of Clause 41, wherein a total number of the plurality of TRPs is two and the fraction is one half.

Clause 43. The method of Clause 40, wherein, according to the specified interpretation operation, the per-TRP maximum number of MIMO uplink layers for each of the plurality of TRPs is equal to the legacy parameter.

Clause 44. The method of any of Clauses 40 through 42, wherein, according to the specified interpretation operation, the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing.

Clause 45. The method of Clause 40 or 43, wherein, according to the specified interpretation operation the per-TRP maximum number of MIMO uplink layers for each of the plurality of TRPs indicates a total number of MIMO uplink layers across the plurality of TRPs divided by a total number of the plurality of TRPs for space division multiplexing.

Clause 46. The method of any of Clauses 40 through 43, wherein, according to the specified interpretation operation, the per-TRP maximum number of MIMO uplink layers for each of the plurality of TRPs indicates a maximum number of MIMO uplink layers per transmission occasion that is associated with a respective SRS resource set for frequency division multiplexing.

Clause 47. The method of any of Clauses 40 through 43, wherein, according to the specified interpretation operation, the per-TRP maximum number of MIMO uplink layers for each of the plurality of TRPs indicates a maximum number of MIMO uplink layers per PUSCH transmission that is associated with a respective SRS resource set for time-domain overlapping.

Clause 48. The method of Clause 33, wherein the layer parameter is a non-legacy parameter for scheduling uplink communication with the plurality of TRPs.

Clause 49. The method of Clause 48, wherein the determining the maximum number of MIMO uplink layers based on the layer parameter comprises determining a per-TRP maximum number of MIMO uplink layers supported by the UE based on the non-legacy parameter, the per-TRP maximum number of MIMO uplink layers being the same for each of the plurality of TRPs.

Clause 50. The method of Clause 49, wherein the per-TRP maximum number of MIMO uplink layers for each of the plurality of TRPs is equal to a MIMO layer number included in the non-legacy parameter.

Clause 51. The method of Clause 49, wherein the per-TRP maximum number of MIMO uplink layers for each of the plurality of TRPs indicates a maximum number of MIMO uplink layers, per set of uplink layers, that is associated with a respective sounding reference signal (SRS) resource set for space division multiplexing.

Clause 52. The method of Clause 49, wherein the per-TRP maximum number of MIMO uplink layers for each of the plurality of TRPs indicates a maximum number of MIMO uplink layers per transmission occasion that is associated with a respective SRS resource set for frequency division multiplexing.

Clause 53. The method of Clause 49, wherein the per-TRP maximum number of MIMO uplink layers for each of the plurality of TRPs indicates a maximum number of MIMO uplink layers per PUSCH transmission that is associated with a respective SRS resource set for time-domain overlapping.

Clause 54. The method of Clause 48, wherein the non-legacy parameter indicates a corresponding maximum number of MIMO uplink layers supported by the UE for each respective TRP of the plurality of TRPs.

Clause 55. The method of Clause 54, wherein the corresponding maximum number of MIMO uplink layers for each respective TRP of the plurality of TRPs indicates a corresponding maximum number of MIMO uplink layers associated with a respective set of uplink layers of a plurality of sets of uplink layers for space division multiplexing, each set of uplink layers of the plurality of sets of uplink layers being respectively associated with a corresponding sounding reference signal (SRS) resource set of a plurality of SRS resource sets, each SRS resource set of the plurality of SRS resource sets being respectively associated with a corresponding TRP of the plurality of TRPs.

Clause 56. The method of Clause 54, wherein the corresponding maximum number of MIMO uplink layers for each respective TRP of the plurality of TRPs indicates a corresponding maximum number of MIMO uplink layers associated with a respective PUSCH transmission of a plurality of PUSCH transmissions for time-domain overlapping, each PUSCH transmission of the plurality of PUSCH transmissions being respectively associated with a corresponding sounding reference signal (SRS) resource set of a plurality of SRS resource sets, each SRS resource set of the plurality of SRS resource sets being respectively associated with a corresponding TRP of the plurality of TRPs.

Clause 57. The method of Clause 48, wherein the non-legacy parameter indicates a total maximum number of MIMO uplink layers supported by the UE for all of the plurality of TRPs.

Clause 58. The method of Clause 57, wherein the total maximum number of MIMO uplink layers indicates a total maximum number of MIMO uplink layers associated with a plurality of sets of uplink layers for space division multiplexing, each set of uplink layers of the plurality of sets of uplink layers being respectively associated with a corresponding sounding reference signal (SRS) set of a plurality of SRS resource sets, each SRS resource set of the plurality of SRS resource sets being respectively associated with a corresponding TRP of the plurality of TRPs.

Clause 59. The method of Clause 57, wherein the total maximum number of MIMO uplink layers indicates a total maximum number of MIMO uplink layers associated with a plurality of transmission occasions for frequency division multiplexing, each transmission occasion of the plurality of transmission occasions being respectively associated with a corresponding sounding reference signal (SRS) resource set of a plurality of SRS resource sets, each SRS resource set of the plurality of SRS resource sets being respectively associated with a corresponding TRP of the plurality of TRPs.

Clause 60. The method of Clause 57, wherein the total maximum number of MIMO uplink layers indicates a total maximum number of MIMO uplink layers associated with a plurality of PUSCH transmissions for time-domain overlapping, each PUSCH transmission of the plurality of PUSCH transmissions being respectively associated with a corresponding sounding reference signal (SRS) set of a plurality of SRS resource sets, each SRS resource set of the plurality of SRS resource sets being respectively associated with a corresponding TRP of the plurality of TRPs.

Clause 61. The method of Clause 48: wherein the non-legacy parameter indicates a per-TRP maximum number of MIMO uplink layers supported by the UE for each of the plurality of TRPs, and wherein the non-legacy parameter further indicates a total maximum number of MIMO uplink layers supported by the UE for all of the plurality of TRPs.

Clause 62. The method of any of Clauses 48 through 61, further comprising: receiving, from the UE, a non-legacy interpretation parameter specifying which interpretation operation to use in determining the maximum number of MIMO uplink layers based on the non-legacy parameter, wherein the determining the uplink scheduling information comprises determining the uplink scheduling information based on the non-legacy parameter and the non-legacy interpretation parameter.

Clause 63. The method of Clause 62, wherein the non-legacy interpretation parameter further includes a multiplex-type indicator indicating a type of multiplexing associated with the specified interpretation operation.

Clause 64. The method of any of Clauses 33 through 63, further comprising: receiving, from the UE, an additional parameter indicating at least one of: a type of PUSCH supported by the UE, the type of PUSCH including at least one of a codebook-based PUSCH or a non-codebook-based PUSCH, a configuration of a PUSCH supported by the UE, the configuration including at least one of a dynamic-granted (DG) PUSCH or a configured-granted (CG) PUSCH, a number of sounding reference signal (SRS) resources per SRS resource set of the UE, a total number of SRS resources for all SRS resource sets of the UE, or a channel state information reference signal (CSI-RS) support indication indicative of whether each CSI-RS resource associated with a respective SRS resource set is supported by the UE, wherein the determining uplink scheduling information comprises determining the uplink scheduling information based on the layer parameter and the additional parameter.

Clause 65. The method of Clause 64, wherein the additional parameter further comprises at least one of: a maximum number of periodic SRS resources associated with first and second CSI-RS resources per bandwidth part (BWP), a maximum number of semi-persistent SRS resources associated with the first and second CSI-RS resource per BWP, or a maximum number of SRS resources associated with the first and second CSI-RS resources that the UE can process simultaneously in a component carrier.

Clause 66: An apparatus, comprising: a memory comprising executable instructions; and a processor configured to execute the executable instructions and cause the apparatus to perform a method in accordance with any one of Clauses 33-65.

Clause 67: An apparatus, comprising means for performing a method in accordance with any one of Clauses 33-65.

Clause 68: A non-transitory computer-readable medium comprising executable instructions that, when executed by a processor of an apparatus, cause the apparatus to perform a method in accordance with any one of Clauses 33-65.

Clause 69: A computer program product embodied on a computer-readable storage medium comprising code for performing a method in accordance with any one of Clauses 33-65.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of wireless communication by a user equipment (UE), comprising:
transmitting, to a plurality of transmission and reception points (TRPs), a layer parameter based on a maximum number of multiple input multiple output (MIMO) uplink layers that are supported by the UE for uplink communication to the plurality of TRPs;
receiving, from at least one TRP of the plurality of TRPs, uplink scheduling information responsive to transmitting the layer parameter; and
transmitting, to each of the plurality of TRPs, a physical uplink shared channel (PUSCH) communication according to the uplink scheduling information.

2. The method of claim 1, further comprising:
generating the layer parameter based on the maximum number of MIMO uplink layers that are supported by the UE for uplink communication.

3. The method of claim 1, wherein the layer parameter is a legacy parameter for scheduling uplink communication with a single TRP, the legacy parameter being repurposed for scheduling uplink communication with the plurality of TRPs.

4. The method of claim 3, further comprising:
transmitting a legacy interpretation parameter specifying which interpretation operation to use in determining the maximum number of MIMO uplink layers based on the legacy parameter.

5. The method of claim 4, wherein the legacy interpretation parameter further includes a multiplex-type indicator indicating a type of multiplexing associated with the specified the interpretation operation.

6. The method of claim 4, wherein the specified interpretation operation indicates how to determine a per-TRP maximum number of MIMO uplink layers supported by the UE based on the legacy parameter, the per-TRP maximum number of MIMO uplink layers being the same for each of the plurality of TRPs.

7. The method of claim 6, wherein, according to the specified interpretation operation, the per-TRP maximum number of MIMO uplink layers for each of the plurality of TRPs is a fraction of the legacy parameter.

8. The method of claim 6, wherein, according to the specified interpretation operation, the per-TRP maximum number of MIMO uplink layers for each of the plurality of TRPs is equal to the legacy parameter.

9. The method of claim 1, wherein the layer parameter is a non-legacy parameter for scheduling uplink communication with the plurality of TRPs.

10. The method of claim 9, wherein the non-legacy parameter is based on a per-TRP maximum number of MIMO uplink layers supported by the UE, the per-TRP maximum number of MIMO uplink layers being the same for each of the plurality of TRPs.

11. The method of claim 10, wherein the per-TRP maximum number of MIMO uplink layers for each of the plurality of TRPs is equal to the non-legacy parameter.

12. The method of claim 10, wherein the per-TRP maximum number of MIMO uplink layers for each of the plurality of TRPs indicates:
a maximum number of MIMO uplink layers, per set of uplink layers, that is associated with a respective sounding reference signal (SRS) resource set for space division multiplexing;
a maximum number of MIMO uplink layers per transmission occasion that is associated with a respective SRS resource set for frequency division multiplexing; or
a maximum number of MIMO uplink layers per PUSCH transmission that is associated with a respective SRS resource set for time-domain overlapping.

13. The method of claim 9, wherein the non-legacy parameter indicates a corresponding maximum number of MIMO uplink layers supported by the UE for each respective TRP of the plurality of TRPs.

14. The method of claim 13, wherein the corresponding maximum number of MIMO uplink layers for each respective TRP of the plurality of TRPs indicates:
a corresponding maximum number of MIMO uplink layers associated with a respective set of uplink layers of a plurality of sets of uplink layers for space division multiplexing, each set of uplink layers of the plurality of sets of uplink layers being respectively associated with a corresponding sounding reference signal (SRS) resource set of a plurality of SRS resource sets, each SRS resource set of the plurality of SRS resource sets being respectively associated with a corresponding TRP of the plurality of TRPs; or
a corresponding maximum number of MIMO uplink layers associated with a respective PUSCH transmission of a plurality of PUSCH transmissions for time-domain overlapping, each PUSCH transmission of the plurality of PUSCH transmissions being respectively associated with a corresponding SRS resource set of a plurality of SRS resource sets, each SRS resource set of the plurality of SRS resource sets being respectively associated with a corresponding TRP of the plurality of TRPs.

15. The method of claim 9, wherein the non-legacy parameter indicates a total maximum number of MIMO uplink layers supported by the UE for all of the plurality of TRPs.

16. The method of claim 15, wherein the total maximum number of MIMO uplink layers indicates:
a total maximum number of MIMO uplink layers associated with a plurality of sets of uplink layers for space division multiplexing, each set of uplink layers of the plurality of sets of uplink layers being respectively associated with a corresponding sounding reference signal (SRS) set of a plurality of SRS resource sets, each SRS resource set of the plurality of SRS resource sets being respectively associated with a corresponding TRP of the plurality of TRPs;
a total maximum number of MIMO uplink layers associated with a plurality of transmission occasions for frequency division multiplexing, each transmission occasion of the plurality of transmission occasions being respectively associated with a corresponding SRS set of a plurality of SRS resource sets, each SRS resource set of the plurality of SRS resource sets being respectively associated with a corresponding TRP of the plurality of TRPs; or
indicates a total maximum number of MIMO uplink layers associated with a plurality of PUSCH transmissions for time-domain overlapping, each PUSCH transmission of the plurality of PUSCH transmissions being respectively associated with a corresponding SRS set of a plurality of SRS resource sets, each SRS resource set of the plurality of SRS resource sets being respectively associated with a corresponding TRP of the plurality of TRPs.

17. The method of claim 9:
wherein the non-legacy parameter indicates a per-TRP maximum number of MIMO uplink layers supported by the UE for each of the plurality of TRPs, and
wherein the non-legacy parameter further indicates a total maximum number of MIMO uplink layers supported by the UE for all of the plurality of TRPs.

18. The method of claim 9, further comprising:
transmitting a non-legacy interpretation parameter specifying which interpretation operation to use in determining the maximum number of MIMO uplink layers based on the non-legacy parameter.

19. The method of claim 18, wherein the non-legacy interpretation parameter further includes a multiplex-type indicator indicating a type of multiplexing associated with the specified the interpretation operation.

20. The method of claim 1, further comprising:
transmitting an additional parameter indicating at least one of:
a type of PUSCH supported by the UE, the type of PUSCH including at least one of a codebook-based PUSCH or a non-codebook-based PUSCH,
a configuration of a PUSCH supported by the UE, the configuration including at least one of a dynamic-granted (DG) PUSCH or a configured-granted (CG) PUSCH,
a number of sounding reference signal (SRS) resources per SRS resource set of the UE,
a total number of SRS resources for all SRS resource sets of the UE, or
a channel state information reference signal (CSI-RS) support indication indicative of whether each CSI-RS resource associated with a respective SRS resource set is supported by the UE.

21. The method of claim 20, wherein the additional parameter further comprises at least one of:
a maximum number of periodic SRS resources associated with first and second CSI-RS resources per bandwidth part (BWP),
a maximum number of semi-persistent SRS resources associated with the first and second CSI-RS resource per BWP, or
a maximum number of SRS resources associated with the first and second CSI-RS resources that the UE can process simultaneously in a component carrier.

22. A user equipment (UE) configured for wireless communications, comprising: a memory comprising computer-executable instructions; and a processor configured to execute the computer-executable instructions and cause the UE to:
transmit, to a plurality of transmission and reception points (TRPs), a layer parameter based on a maximum number of multiple input multiple output (MIMO) uplink layers that are supported by the UE for uplink communication to the plurality of TRPs;
receive, from at least one TRP of the plurality of TRPs, uplink scheduling information responsive to transmitting the layer parameter; and
transmit, to each of the plurality of TRPs, a physical uplink shared channel (PUSCH) communication according to the uplink scheduling information.

23. A method of wireless communication by a TRP, comprising:
receiving, from a user equipment (UE), a layer parameter;
determining, based on the layer parameter, a maximum number of multiple input multiple output (MIMO) uplink layers supported by the UE for uplink communication to a plurality of transmission and reception points (TRPs);
determining uplink scheduling information based on the maximum number of MIMO uplink layers;
transmitting, to the UE, the uplink scheduling information; and
receiving, from the UE, a physical uplink shared channel (PUSCH) communication according to the uplink scheduling information.

24. The method of claim 23, wherein the layer parameter is a legacy parameter for scheduling uplink communication with a single TRP, the legacy parameter being repurposed for scheduling uplink communication with the plurality of TRPs.

25. The method of claim 24, wherein the determining the maximum number of MIMO uplink layers comprises determining the maximum number of MIMO uplink layers based on the legacy parameter and further based on a legacy interpretation parameter, the legacy interpretation parameter specifying which interpretation operation to use in determining the maximum number of MIMO uplink layers based on the legacy parameter.

26. The method of claim 25, wherein the determining the maximum number of MIMO uplink layers based on the layer parameter comprises determining, according to the specified interpretation operation, a per-TRP maximum number of MIMO uplink layers supported by the UE based on the legacy parameter, the per-TRP maximum number of MIMO uplink layers being the same for each of the plurality of TRPs.

27. The method of claim 26, wherein, according to the specified interpretation operation, the per-TRP maximum number of MIMO uplink layers for each of the plurality of TRPs indicates:
a maximum number of MIMO uplink layers, per set of uplink layers, that is associated with a respective sounding reference signal (SRS) resource set for space division multiplexing;
a total number of MIMO uplink layers across the plurality of TRPs divided by a total number of the plurality of TRPs for space division multiplexing;
a maximum number of MIMO uplink layers per transmission occasion that is associated with a respective SRS resource set for frequency division multiplexing; or
a maximum number of MIMO uplink layers per PUSCH transmission that is associated with a respective SRS resource set for time-domain overlapping.

28. The method of claim 23, wherein the layer parameter is a non-legacy parameter for scheduling uplink communication with the plurality of TRPs.

29. The method of claim 28:
wherein the non-legacy parameter indicates a per-TRP maximum number of MIMO uplink layers supported by the UE for each of the plurality of TRPs, and
wherein the non-legacy parameter further indicates a total maximum number of MIMO uplink layers supported by the UE for all of the plurality of TRPs.

30. A transmission reception point (TRP) configured for wireless communications, comprising: a memory comprising computer-executable instructions; and a processor configured to execute the computer-executable instructions and cause the TRP to:
receive, from a user equipment (UE), a layer parameter;
determine, based on the layer parameter, a maximum number of multiple input multiple output (MIMO) uplink layers supported by the UE for uplink communication to a plurality of TRPs;
determine uplink scheduling information based on the maximum number of MIMO uplink layers;
transmit, to the UE, the uplink scheduling information; and
receive, from the UE, a physical uplink shared channel (PUSCH) communication according to the uplink scheduling information.
